(19) United States
(12) Patent Application Publication
(10) Pub. No.: US 2026/0242603 A1
(43) Pub. Date: Aug. 20, 2026

(54) PLASTIC COMPOSITION, EXTRUSION PROFILE WITH PLASTIC COMPOSITION AND METHOD FOR PRODUCING AN EXTRUSION PROFILE

(71) Applicant: SALAMANDER INDUSTRIE-PRODUKTE GMBH, Türkheim (DE)

(72) Inventors: Till Schmiedeknecht, München (DE); Shyam Abimannan, Bad Wörishofen (DE); Adnane Charifi, Türkheim (DE)

(73) Assignee: SALAMANDER INDUSTRIE-PRODUKTE GMBH, Türkheim (DE)

(21) Appl. No.: 19/126,926

(22) PCT Filed: Nov. 3, 2023
(86) PCT No.: PCT/EP2023/080717

§ 371 Date: May 2, 2025

(30) Foreign Application Priority Data
Nov. 4, 2022 (DE) 10 2022 129 185.5

(51) Int. Cl. C08L 97/00; B29C 48/00; B29K 1/00; B29K 27/06; B29K 96/02; B29L 23/00; B29L 31/00; C08K 3/26; C08K 5/00; C08K 5/07; C08K 5/098; C08K 5/3492; C08L 1/02; C08L 27/06; C08L 51/06

(52) U.S. Cl. CPC C08L 97/005; B29C 48/022; C08K 3/26; C08K 5/0091; C08K 5/07; C08K 5/098; C08K 5/34924; C08L 1/02; C08L 27/06; C08L 51/06; B29K 2001/00; B29K 2027/06; B29K 2096/02; B29L 2023/00; B29L 2031/005; C08K 2003/265; C08L 2205/03

(57) ABSTRACT

A plastic composition for producing extruded profiles, such as extruded window frame profiles or tubular profiles, may include from 0.1 to 40% by weight of a polysaccharide, a lignin derivative or a mixture of two or more thereof, and from 10 to 99.9% by weight of a halogen-containing polymer, each being based on the total weight of the plastic composition.

### CROSS REFERENCE TO RELATED APPLICATIONS

This patent application is a U.S. National Stage Application of PCT International Application No. PCT/EP2023/080717, filed Nov. 3, 2023, which claims priority to German Application No. 10 2022 129 185.5, filed Nov. 4, 2022, each of which is incorporated herein by reference in its entirety.

### BACKGROUND

### Field

The disclosure relates to a plastic composition, an extrusion profile with a plastic composition, the use of a plastic composition for producing an extrusion profile and a method for producing an extrusion profile. In particular, the disclosure relates to a plastic composition for producing extrusion profiles, in particular extruded window frame profiles or tubular profiles.

### Related Art

It is known to use steel reinforcements or inserts for reinforcing extrusion profiles. On account of the associated high weight and the high energy consumption for producing steel, various alternatives for reinforcing extrusion profiles are discussed in the literature.

For example, it is known to reinforce extrusion profiles by means of unidirectionally aligned reinforcing fibers lying next to one another. Compared with the steel reinforcement, this method is distinguished by a lower weight of the profiles produced therewith. However, the performance, that is to say the mechanical load-bearing capacity, is also significantly lower here than in the case of a steel reinforcement. Furthermore, in this method, a full extrusion is used which has disadvantages in terms of process technology compared with a conventional extrusion. In order to further increase the mechanical load-bearing capacity at low weight, WO 2011/050899 describes a method for producing fiber-reinforced extrusion profiles, wherein firstly an organosheet composed of a plastic matrix, into which reinforcing fibers are integrated, is preheated and this is then extruded into a basic plastic matrix.

Although it is possible with these methods to increase the mechanical load-bearing capacity at relatively low weight. However, these solutions require the use of extrusion methods which are complicated in terms of process technology. Furthermore, the production of reinforcing fibers and fiber-matrix semi-finished products is energy-intensive. A further problem is the poor recyclability of fiber-reinforced plastics.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 is a cross-sectional view of window frame profile according to the disclosure.

FIG. 2 is a plot of test results according to the disclosure.

FIG. 3 is a plot of test results according to the disclosure.

FIG. 4 is a plot of impact strengths according to the disclosure.

FIG. 5 is a plot of impact strengths according to the disclosure.

FIG. 6 is a plot of Brabender/measuring kneader results according to the disclosure.

FIG. 7 is a plot of Brabender/measuring kneader results according to the disclosure.

FIG. 8 is a plot of Brabender/measuring kneader results according to the disclosure.

FIG. 9 is a plot of flexural modulus results according to the disclosure.

FIG. 10 is a plot of corner strength results according to the disclosure.

FIG. 11 is a plot of Vicat softening temperature results according to the disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, and components, have not been described in detail to avoid unnecessarily obscuring embodiments of the disclosure.

It is an object of the disclosure to overcome the disadvantages of the prior art, in particular to provide a plastic composition, an extrusion profile with a plastic composition, the use of a plastic composition for producing an extrusion profile and a method for producing an extrusion profile, with which the mechanical load-bearing capacity is increased compared with conventional plastic profiles without reinforcement and the process requirements, the recyclability, the energy consumption and/or the weight for the production are improved compared with known measures for reinforcing extrusion profiles.

According to a first aspect of the disclosure, a composition for producing extrusion profiles, in particular extruded window frame profiles or tubular profiles, is provided, comprising:
0.1 to 40% by weight of a polysaccharide, a lignin derivative or a mixture of two or more thereof; and
10 to 99.9% by weight of a halogen-containing polymer;
   each based on the total weight of the composition.

It may be provided that the polysaccharide, the lignose derivative or the mixture of two or more thereof is comprised in the composition in an amount selected from the group consisting of at least 0.5% by weight, at least 1% by weight, at least 1.5% by weight, at least 2.0% by weight, at least 2.5% by weight, at least 3.0% by weight, at least 4.0% by weight, at least 5.0% by weight, at least 6.0% by weight, at least 7.0% by weight or at least 8.0% by weight, based on the total weight of the composition.

It may be provided that the polysaccharide, the lignose derivative or the mixture of two or more thereof is comprised in the composition in an amount selected from the group consisting of at most 40% by weight, at most 30% by weight, at most 20% by weight, at most 15% by weight, at most 10% by weight or at most 9% by weight, at most 6% by weight, at most 4% by weight and at most 3.5% by weight, based on the total weight of the composition.

It may be provided that the polysaccharide, the lignose derivative or the mixture of two or more thereof is comprised in the composition in an amount selected from the group consisting of 0.5 to 40% by weight, 1 to 30% by weight, 1.5 to 20% by weight, 2 to 15% by weight and 2.5 to 10% by weight, for example about 3% by weight, based on the total weight of the composition.

Polysaccharides in the sense of the present disclosure are carbohydrates in which a large number (at least eleven) monosaccharides (simple sugars) are linked via a glycosidic bond. It may be provided that the polysaccharide is selected from the group consisting of glycogen, starch (amylose and amylopectin), pectins, chitin, callose and cellulose. It may be provided that the polysaccharide comprises cellulose. It may be provided that the polysaccharide is cellulose. In particular if the polysaccharide comprises cellulose or is cellulose, it may be provided that the cellulose is comprised in the composition in an amount of at least 2.4% by weight, preferably at least 4% by weight, particularly preferably at least 5.6% by weight or 8% by weight, parts by weight based on the total weight of the composition. A corresponding exemplary cellulose is, for example, the commercially available product Cellulose Arbocell FD 600-30.

Lignins form a group of phenolic macromolecules which are composed of various monomer building blocks. They are solid biopolymers which are incorporated into the plant cell wall. A substance is referred to as a derivative of a parent compound in the sense of the present disclosure if it has a structural unit which is similar to the functional group of the parent compound and contains a structural element of this functional group in the same oxidation state. It may be provided that the lignin derivative comprises a lignosulfonate. It may be provided that the lignin derivative is lignosulfonate. A corresponding exemplary lignin derivative is, for example, the commercially available product Starlig®Ca from LignoStar.

It may be provided that the halogen-containing polymer is comprised in the composition in an amount selected from the group consisting of at least 20% by weight, at least 30% by weight, at least 40% by weight, at least 50% by weight, at least 55% by weight, at least 60% by weight, at least 70% by weight, at least 75% by weight and at least 78% by weight, based on the total weight of the composition.

It may be provided that the halogen-containing polymer is comprised in the composition in an amount selected from the group consisting of at most 99% by weight, at most 95% by weight, at most 92% by weight, at most 90% by weight, at most 87.5% by weight, at most 85% by weight and at most 82% by weight, based on the total weight of the composition.

It may be provided that the halogen-containing polymer is comprised in the composition in an amount selected from the group consisting of 20 to 99% by weight, 30 to 95% by weight, 40 to 92% by weight, 50 to 90% by weight, 60 to 87.5% by weight, 75 to 85% by weight and 78 to 82% by weight, for example about 80% by weight, based on the total weight of the composition.

The inventors have recognized that, in particular, fractions of more than 15% by weight, based on the total weight of the plastic composition, of elastomers, in particular of homo- and copolymers of vinyl acetate and/or ethylene, in particular of ethylene-vinyl acetate copolymers, have a negative effect on the mechanical properties of the plastic composition, in particular such a negative effect that the materials can no longer be used for producing extrusion profiles, but at best as material for foaming extrusion profiles, such as door and window frame profiles. Furthermore, elastomers, such as ethylene-vinyl acetate copolymers, are expensive. Accordingly, it may be provided that the plastic composition has a fraction of at most 15% by weight, preferably of at most 10% by weight, 5% by weight, 3% by weight, 1% by weight, 0.5% by weight, 0.1% by weight, is particularly preferably free of elastomers, in particular of homo- and copolymers of vinyl acetate and/or ethylene, for example of ethylene-vinyl acetate copolymers. Alternatively, or additionally, the plastic composition comprises a fraction of at most 0.5% by weight, 0.3% by weight, 0.1% by weight, 0.05% by weight, 0.01% by weight, is preferably free of foam stabilizers.

In the sense of the present disclosure, a halogen-containing polymer is in particular a hydrocarbon-based polymer in which at least one hydrogen atom per monomer unit has been replaced by one of the halogens fluorine, chlorine, bromine or iodine. In the case of a copolymer, at least one hydrogen atom per comonomer unit of at least one of the comonomers has been replaced by one of the halogens fluorine, chlorine, bromine or iodine. It may be provided that the halogen-containing polymer comprises a chlorine-containing polymer, a fluorine-containing polymer or a chlorine- and fluorine-containing polymer, in particular consists of at least 10% by weight, 20% by weight, 30% by weight, 40% by weight, 50% by weight, 60% by weight, 70% by weight, 80% by weight, 90% by weight, 95% by weight, 98% by weight, 99% by weight, 99.5% by weight, 99.9% by weight or 100% by weight thereof. It may be provided that the halogen-containing polymer is selected, in particular at least 10% by weight, 20% by weight, 30% by weight, 40% by weight, 50% by weight, 60% by weight, 70% by weight, 80% by weight, 90% by weight, 95% by weight, 98% by weight, 99% by weight, 99.5% by weight, 99.9% by weight or 100% by weight thereof, from polyvinyl chloride, chlorinated polyethylene, polytetrafluoroethylene, polytrichlorofluoroethylene, polyvinylidene fluoride or mixtures of two or more thereof. It may be provided that the halogen-containing polymer comprises polyvinyl chloride, in particular at least 10% by weight, 20% by weight, 30% by weight, 40% by weight, 50% by weight, 60% by weight, 70% by weight, 80% by weight, 90% by weight, 95% by weight, 98% by weight, 99% by weight, 99.5% by weight, 99.9% by weight thereof. It may be provided that the halogen-containing polymer is polyvinyl chloride. It may be provided that the halogen-containing polymer consists of at least one first polyvinyl chloride and of at least one second polyvinyl chloride.

The inventors have recognized that the use of halogen-containing polymer, in particular of polyvinyl chloride, in the plastic composition according to the disclosure makes it possible to provide extrusion profiles with particularly good mechanical properties, in particular with high strength. Furthermore, halogen-containing polymers, in particular polyvinyl chloride, have cost advantages over other polymers, for example elastomers, such as ethylene-vinyl acetate copolymers.

It may be provided that the halogen-containing polymer consists of a first polyvinyl chloride and of a second polyvinyl chloride. It may be provided that the first polyvinyl chloride and the second polyvinyl chloride are present in the halogen-containing polymer in a weight ratio selected from the group consisting of from 10:1 to 1:10, from 5:1 to 1:5 and from 2:1 to 1:2, in particular in a weight ratio of approximately 6:4.

It may be provided that the first polyvinyl chloride has a K value according to DIN EN ISO 1628-2 (in the version valid on the filing date) selected from the group consisting of from 60 to 70, from 65 to 69, from 65 to 68, and 67.5 to 68.5, in particular approximately 68. It may be provided that the first polyvinyl chloride has a bulk density according to DIN EN ISO 60 (in the version valid on the filing date) selected from the group consisting of from 0.4 to 0.8 g/cm³ and from 0.5 to 0.6 g/cm³, in particular approximately 0.57. It may be provided that the first polyvinyl chloride has a value of sieve analysis—residue on 0.063 mm sieve according to DIN EN ISO 4610 (in the version valid on the filing date) selected from the group consisting of at least 90% and at least 95%, in particular at least approximately 96%. It may be provided that the first polyvinyl chloride has a value of sieve analysis—residue on 0.250 mm sieve according to DIN EN ISO 4610 (in the version valid on the filing date) selected from the group consisting of at least 1% and at least 2%, in particular at least approximately 3%. It may be provided that the first polyvinyl chloride has a proportion of volatile constituents according to DIN EN ISO 1269 selected from the group consisting of at most 1% and at most 0.5%, in particular at most approximately 0.3%. It may be provided that the first polyvinyl chloride has a plasticizer absorption according to ISO 4608 (in the version valid on the filing date) selected from the group consisting of from 10 to 30%, from 15 to 25% and from 18 to 22%, in particular approximately 20%. A corresponding commercially available first polyvinyl chloride is, for example, Vynova S6830.

It may be provided that the second polyvinyl chloride has a K value according to DIN EN ISO 1628-2 (in the version valid on the filing date) selected from the group consisting of from 60 to 70, from 63 to 68, from 65 to 68, from 65 to 67 and from 65.5 to 66.5, in particular approximately 66. It may be provided that the second polyvinyl chloride has a bulk density according to DIN EN ISO 60 (in the version valid on the filing date) selected from the group consisting of from 0.4 to 0.8 g/cm³ and from 0.5 to 0.6 g/cm³, in particular approximately 0.56. It may be provided that the second polyvinyl chloride has a value of sieve analysis—residue on 0.063 mm sieve according to DIN EN ISO 4610 (in the version valid on the filing date) selected from the group consisting of at least 90% and at least 95%, in particular at least approximately 97%. It may be provided that the second polyvinyl chloride has a value of sieve analysis—residue on 0.200 mm sieve according to DIN EN ISO 4610 (in the version valid on the filing date) selected from the group consisting of at most 20% and at most 17%, in particular at most approximately 15%. It may be provided that the second polyvinyl chloride has a proportion of volatile constituents according to DIN EN ISO 1269 selected from the group consisting of at most 1% and at most 0.5%, in particular at most approximately 0.3%. A corresponding commercially available second polyvinyl chloride is, for example, Primex S 6658 from vestolit.

It may be provided that the composition further comprises a heat stabilizer.

Plastics are sensitive to the action of heat. Above a temperature characteristic for the material (decomposition temperature), the decomposition of the molecular structure sets in. Heat stabilizers serve to prevent this.

It may be provided that the heat stabilizer is comprised in the composition in an amount selected from the group consisting of at least 0.01% by weight, at least 0.05% by weight, at least 0.1% by weight, at least 0.2% by weight, at least 0.3% by weight, at least 0.4% by weight, at least 0.5% by weight, at least 0.6% by weight and at least 0.7% by weight, based on the total weight of the composition.

It may be provided that the heat stabilizer is comprised in the composition in an amount selected from the group consisting of at most 10% by weight, at most 7.5% by weight, at most 5% by weight, at most 2.5% by weight, at most 2% by weight, at most 1.5% by weight, at most 1.25% by weight, at most 1% by weight and at most 0.9% by weight, based on the total weight of the composition.

It may be provided that the heat stabilizer is comprised in the composition in an amount selected from the group consisting of 0.01 to 10% by weight, 0.1 to 7.5% by weight, 0.2 to 5% by weight, 0.3 to 2.5% by weight, 0.4 to 2% by weight, 0.5 to 1.5% by weight, 0.6 to 1.25% by weight and 0.7 to 0.9% by weight, for example about 0.8% by weight, based on the total weight of the composition.

It may be provided that the heat stabilizer comprises an organic barium, zinc, tin and cadmium compound and/or an inorganic lead salt. It may be provided that the heat stabilizer comprises an organic barium compound and/or an organic cadmium compound. It may be provided that the heat stabilizer comprises an organic barium compound and an organic cadmium compound. It may be provided that the heat stabilizer comprises zinc stearate, calcium stearate or a mixture thereof. It may be provided that the heat stabilizer comprises a mixture of zinc stearate and calcium stearate in a weight ratio of 1:1 to 5:1 in an amount of at least 90% by weight, based on the total weight of the heat stabilizer. It may be provided that the heat stabilizer consists of a mixture of zinc stearate and calcium stearate in a weight ratio of 1:1 to 5:1. It may be provided that the heat stabilizer consists of a mixture of zinc stearate and calcium stearate in a weight ratio of 2:1 to 3:1. A corresponding exemplary zinc stearate is, for example, the commercially available product Ligastar Zn 101/6. A corresponding exemplary calcium stearate is, for example, the commercially available product Ligastar CA 600.

It may be provided that the zinc stearate is comprised in the composition in an amount selected from the group consisting of 0.05 to 5.0% by weight, 0.1 to 2.0% by weight, 0.2 to 1.0% by weight, 0.3 to 1.0% by weight, 0.4 to 0.8% by weight and 0.5 to 0.6% by weight, for example about 0.55% by weight, based on the total weight of the composition and/or that the calcium stearate is comprised in the composition in an amount selected from the group consisting of 0.01 to 2.5% by weight, 0.05 to 1.0% by weight, 0.1 to 1.0% by weight, 0.15 to 0.5% by weight and 0.2 to 0.3% by weight, for example about 0.24% by weight, based on the total weight of the composition.

It may be provided that the composition further comprises a co-stabilizer.

It may be provided that the co-stabilizer is comprised in the composition in an amount selected from the group consisting of at least 0.01% by weight, at least 0.05% by weight, at least 0.1% by weight, at least 0.2% by weight, at least 0.3% by weight and at least 0.4% by weight, based on the total weight of the composition.

It may be provided that the co-stabilizer is comprised in the composition in an amount selected from the group consisting of at most 5% by weight, at most 4% by weight, at most 3% by weight, at most 2% by weight, at most 1% by weight and at most 0.5% by weight, based on the total weight of the composition.

It may be provided that the co-stabilizer is comprised in the composition in an amount selected from the group consisting of 0.01 to 5% by weight, 0.05 to 4% by weight, 0.1 to 3% by weight, 0.2 to 2% by weight, 0.3 to 1% by weight and 0.3 to 0.5% by weight, for example about 0.4% by weight, based on the total weight of the composition.

It may be provided that the co-stabilizer comprises a nucleophilic compound, an antioxidant, an acid scavenger or a mixture of two or more thereof. It may be provided that the co-stabilizer comprises a mixture of at least one nucleophilic compound, at least one antioxidant and at least one acid scavenger.

It may be provided that the nucleophilic compound comprises an organic compound having two or more, preferably three, hydroxyl groups, for example tris(2-hydroxyethyl)isocyanurate, β-diketone. It may be provided that the nucleophilic compound comprises, or consists of, tris(2-hydroxyethyl)isocyanurate, β-diketone, calcium acetylacetonate or a mixture of two or more thereof. It may be provided that the nucleophilic compound comprises, or consists of, a mixture of tris(2-hydroxyethyl)isocyanurate, β-diketone and calcium acetylacetonate.

It may be provided that the calcium acetylacetonate is comprised in the composition in an amount selected from the group consisting of 0.01 to 2.0% by weight, 0.02 to 1.0% by weight, 0.03 to 0.6% by weight, 0.04 to 0.3% by weight, 0.05 to 0.2% by weight and 0.06 to 0.1% by weight, for example about 0.07% by weight, based on the total weight of the composition.

It may be provided that the tris(2-hydroxyethyl)isocyanurate is comprised in the composition in an amount selected from the group consisting of 0.01 to 5.0% by weight, 0.03 to 2.0% by weight, 0.05 to 1.0% by weight, 0.08 to 0.7% by weight, 0.1 to 0.5% by weight and 0.12 to 0.2% by weight, for example about 0.14% by weight, based on the total weight of the composition.

It may be provided that the sodium aluminosilicate is comprised in the composition in an amount selected from the group consisting of 0.01 to 2.0% by weight, 0.01 to 1.0% by weight, 0.02 to 0.6% by weight, 0.03 to 0.3% by weight, 0.04 to 0.2% by weight and 0.05 to 0.1% by weight, for example about 0.06% by weight, based on the total weight of the composition.

It may be provided that the β-diketone is comprised in the composition in an amount selected from the group consisting of 0.01 to 2.0% by weight, 0.02 to 1.0% by weight, 0.03 to 0.6% by weight, 0.05 to 0.3% by weight, 0.06 to 0.2% by weight and 0.07 to 0.1% by weight, for example about 0.08% by weight, based on the total weight of the composition.

It may be provided that the antioxidant is a sterically hindered phenolic compound, for example octadecyl-[3-(3,5-di-tert-butyl-4-hydroxyphenyl)propionate], which is commercially available as Irganox 1076.

It may be provided that the antioxidant, in particular the sterically hindered phenolic compound, preferably octadecyl-[3-(3,5-di-tert-butyl-4-hydroxyphenyl)propionate], is comprised in the composition in an amount selected from the group consisting of 0.01 to 2.0% by weight, 0.02 to 1.0% by weight, 0.03 to 0.6% by weight, 0.04 to 0.3% by weight, 0.05 to 0.2% by weight and 0.06 to 0.1% by weight, for example about 0.07% by weight, based on the total weight of the composition.

It may be provided that the acid scavenger comprises, or consists of, hydrotalcite, zeolite or a mixture of two or more thereof, preferably comprises, or consists of, a mixture of hydrotalcite and zeolite.

It may be provided that the composition further comprises a lubricant.

It may be provided that the lubricant is comprised in the composition in an amount selected from the group consisting of at least 0.01% by weight, at least 0.05% by weight, at least 0.1% by weight, at least 0.3% by weight, at least 0.5% by weight and at least 0.7% by weight, based on the total weight of the composition.

It may be provided that the lubricant is comprised in the composition in an amount selected from the group consisting of at most 5% by weight, at most 4% by weight, at most 3% by weight, at most 2% by weight, at most 1% by weight and at most 0.8% by weight, based on the total weight of the composition.

It may be provided that the lubricant is comprised in the composition in an amount selected from the group consisting of 0.01 to 5% by weight, 0.05 to 4% by weight, 0.1 to 3% by weight, 0.2 to 2% by weight, 0.4 to 1% by weight and 0.6 to 0.9% by weight, for example about 0.75% by weight, based on the total weight of the composition.

It may be provided that the lubricant comprises (or consists of) at least one selected from the group consisting of a fatty acid, in particular 12-hydroxystearic acid, an oil, in particular hydrogenated castor oil, a wax, in particular low density polyethylene (LDPE) wax, a paraffin, in particular Fischer-Tropsch paraffin, oxidized polyethylenes, complex esters and a mixture of two or more thereof. It may be provided that the lubricant comprises a mixture of 12-hydroxystearic acid, hydrogenated castor oil, low density polyethylene (LDPE) wax, Fischer-Tropsch paraffin and oxidized polyethylenes. It may be provided that the lubricant consists of a mixture of 12-hydroxystearic acid, hydrogenated castor oil, low density polyethylene (LDPE) wax, Fischer-Tropsch paraffin and oxidized polyethylenes.

It may be provided that the 12-hydroxystearic acid is comprised in the composition in an amount selected from the group consisting of 0.01 to 2.5% by weight, 0.05 to 1.5% by weight, 0.1 to 1.0% by weight, 0.2 to 0.7% by weight, 0.3 to 0.5% by weight and 0.2 to 0.4% by weight, for example about 0.3% by weight, based on the total weight of the composition.

It may be provided that the hydrogenated castor oil is comprised in the composition in an amount selected from the group consisting of 0.01 to 2.0% by weight, 0.05 to 1.0% by weight, 0.08 to 0.6% by weight, 0.1 to 0.4% by weight, 0.12 to 0.3% by weight and 0.14 to 0.2% by weight, for example about 0.16% by weight, based on the total weight of the composition.

It may be provided that the low density polyethylene (LDPE) wax is comprised in the composition in an amount selected from the group consisting of 0.01 to 2.0% by weight, 0.05 to 1.0% by weight, 0.08 to 0.6% by weight, 0.1 to 0.4% by weight, 0.15 to 0.3% by weight and 0.18 to 0.25% by weight, for example about 0.2% by weight, based on the total weight of the composition.

It may be provided that the Fischer-Tropsch paraffin is comprised in the composition in an amount selected from the group consisting of 0.01 to 2.0% by weight, 0.02 to 1.0% by weight, 0.03 to 0.6% by weight, 0.04 to 0.3% by weight, 0.05 to 0.2% by weight and 0.06 to 0.1% by weight, for example about 0.07% by weight, based on the total weight of the composition.

It may be provided that the oxidized polyethylenes is comprised in the composition in an amount selected from the group consisting of 0.01 to 2.0% by weight, 0.01 to 1.0% by weight, 0.02 to 0.6% by weight, 0.03 to 0.3% by weight, 0.04 to 0.2% by weight and 0.05 to 0.1% by weight, for example about 0.06% by weight, based on the total weight of the composition.

It may be provided that the composition further comprises a flow agent.

It may be provided that the flow agent is comprised in the composition in an amount selected from the group consisting of at least 1% by weight, at least 2% by weight, at least 3% by weight and at least 4% by weight, based on the total weight of the composition.

It may be provided that the flow agent is comprised in the composition in an amount selected from the group consisting of at most 10% by weight, at most 9% by weight, at most 8% by weight, at most 7% by weight, at most 6% by weight and at most 5% by weight, based on the total weight of the composition.

It may be provided that the flow agent is comprised in the composition in an amount selected from the group consisting of 1 to 10% by weight, 2 to 9% by weight, 3 to 8% by weight and 4 to 6% by weight, based on the total weight of the composition.

It may be provided that the flow agent comprises or consists of acrylic-based or (meth)acrylic-based particles, in particular comprises acrylic-based or (meth)acrylic-based particles having a median particle size in a range from 50 to 300 μm. A corresponding commercially available product is, for example, Paraloid K125.

It may be provided that the composition further comprises an impact strength modifier.

It may be provided that the impact strength modifier is comprised in the composition in an amount selected from the group consisting of at least 1% by weight, at least 2% by weight, at least 3% by weight and at least 4% by weight, based on the total weight of the composition.

It may be provided that the impact strength modifier is comprised in the composition in an amount selected from the group consisting of at most 10% by weight, at most 9% by weight, at most 8% by weight, at most 7% by weight, at most 6% by weight and at most 5% by weight, based on the total weight of the composition.

It may be provided that the impact strength modifier is comprised in the composition in an amount selected from the group consisting of 1 to 10% by weight, 2 to 9% by weight, 3 to 8% by weight and 4 to 6% by weight, based on the total weight of the composition.

It may be provided that the impact strength modifier is an acrylic polymer, for example an acrylic polymer having a D50 particle size of 200 μm and/or a bulk density of 0.4 to 0.5 g/cm³. A corresponding commercially available product is, for example, Kaneka FM 56 K3.

It may be provided that the composition further comprises CaCO₃, in particular as an agent for improving the mechanical properties of a product obtained by means of the composition. Suitable commercially available products are, for example, Precarb 400 or Microcarb 95T.

It may be provided that the CaCO₃ is comprised in the composition in an amount selected from the group consisting of at least 1% by weight, at least 3% by weight, at least 4% by weight and at least 5% by weight and at least 6% by weight, based on the total weight of the composition.

It may be provided that the CaCO₃ is comprised in the composition in an amount selected from the group consisting of at most 15% by weight, at most 12.5% by weight, at most 10% by weight, at most 8% by weight and at most 7% by weight, based on the total weight of the composition.

It may be provided that the CaCO₃ is comprised in the composition in an amount selected from the group consisting of 1 to 15% by weight, 3 to 10% by weight, 4 to 8% by weight and 6 to 7% by weight, based on the total weight of the composition.

It may be provided that the composition further comprises an adhesion promoter.

It may be provided that the adhesion promoter is comprised in the composition in an amount selected from the group consisting of at least 0.01% by weight, at least 0.04% by weight, at least 0.08% by weight and at least 0.16% by weight, based on the total weight of the composition.

It may be provided that the adhesion promoter is comprised in the composition in an amount selected from the group consisting of at most 5% by weight, at most 1.6% by weight, at most 0.8% by weight and at most 0.4% by weight, based on the total weight of the composition.

It may be provided that the adhesion promoter is comprised in the composition in an amount selected from the group consisting of 0.01 to 5% by weight, 0.04 to 1.6% by weight, 0.08 to 0.8% by weight, 0.16 to 0.4% by weight, based on the total weight of the composition.

Adhesion promoters according to the present disclosure are substances which produce a tight physical or usually chemical bond in the interface of immiscible substances. It may be provided that the adhesion promoter is a modified polyolefin, in particular a polyolefin modified with chlorine and/or maleic anhydride. It may be provided that the adhesion promoter is maleic acid-grafted polyethylenes or consists thereof. A corresponding commercially available adhesion promoter is, for example, Licocene PE MA 4221.

It may be provided that the composition further comprises a colorant.

It may be provided that the colorant is comprised in the composition in an amount selected from the group consisting of at least 1% by weight, at least 2% by weight and at least 3% by weight, based on the total weight of the composition.

It may be provided that the colorant is comprised in the composition in an amount selected from the group consisting of at most 8% by weight, at most 7% by weight, at most 6% by weight and at most 5% by weight, based on the total weight of the composition.

It may be provided that the colorant is comprised in the composition in an amount selected from the group consisting of 1 to 8% by weight, 2 to 6% by weight and 3 to 5% by weight, for example about 4% by weight, based on the total weight of the composition.

It may be provided that the colorant is selected from the group consisting of TiO2 pigment, blue pigment, violet pigment and a mixture of two or more thereof, in particular comprises a mixture of TiO2 pigment, blue pigment and violet pigment. Corresponding commercially available products are, for example, TiO₂ RFK-3, pigment blue and pigment violet.

It may be provided that the composition further comprises Mg(OH)₂, in particular as an agent for improving the thermostability determined by dehydrochlorination. A corresponding commercially available product is, for example, Luvomaag H002.

It may be provided that the Mg(OH)₂ is comprised in the composition in an amount selected from the group consisting of at least 0.01% by weight, at least 0.04% by weight, at least 0.08% by weight and at least 0.16% by weight, based on the total weight of the composition.

It may be provided that the Mg(OH)₂ is comprised in the composition in an amount selected from the group consisting of at most 5% by weight, at most 1.6% by weight, at most 0.8% by weight and at most 0.4% by weight, based on the total weight of the composition.

It may be provided that the Mg(OH)₂ is comprised in the composition in an amount selected from the group consisting of 0.01 to 5% by weight, 0.04 to 1.6% by weight, 0.08 to 0.8% by weight, 0.16 to 0.4% by weight, based on the total weight of the composition.

According to a second aspect of the disclosure, a composition for producing extrusion profiles, in particular extruded window frame profiles or tubular profiles, is provided, comprising:
a polysaccharide, a lignin derivative or a mixture of two or more thereof; and
55 to 99.9% by weight of a polymer;
   each based on the total weight of the composition.

It may be provided that the polysaccharide, the lignose derivative or the mixture of two or more thereof is comprised in the composition in an amount selected from the group consisting of at least 0.5% by weight, at least 1% by weight, at least 1.5% by weight, at least 2.0% by weight, at least 2.5% by weight, at least 3.0% by weight, at least 4.0% by weight, at least 5.0% by weight, at least 6.0% by weight, at least 7.0% by weight or at least 8.0% by weight, based on the total weight of the composition.

It may be provided that the polysaccharide, the lignose derivative or the mixture of two or more thereof is comprised in the composition in an amount selected from the group consisting of at most 40% by weight, at most 30% by weight, at most 20% by weight, at most 15% by weight, at most 10% by weight or at most 9% by weight, at most 6% by weight, at most 4% by weight and at most 3.5% by weight, based on the total weight of the composition.

It may be provided that the polysaccharide, the lignose derivative or the mixture of two or more thereof is comprised in the composition in an amount selected from the group consisting of 0.5 to 40% by weight, 1 to 30% by weight, 1.5 to 20% by weight, 2 to 15% by weight and 2.5 to 10% by weight, for example about 3% by weight, based on the total weight of the composition.

Polysaccharides in the sense of the present disclosure are carbohydrates in which a large number (at least eleven) monosaccharides (simple sugars) are linked via a glycosidic bond. It may be provided that the polysaccharide is selected from the group consisting of glycogen, starch (amylose and amylopectin), pectins, chitin, callose and cellulose. It may be provided that the polysaccharide comprises cellulose. It may be provided that the polysaccharide is cellulose. In particular if the polysaccharide comprises cellulose or is cellulose, it may be provided that the cellulose is comprised in the composition in an amount of at least 2.4% by weight, preferably at least 4% by weight, particularly preferably at least 5.6% by weight or 8% by weight, parts by weight based on the total weight of the composition. A corresponding exemplary cellulose is, for example, the commercially available product Cellulose Arbocell FD 600-30.

Lignins form a group of phenolic macromolecules which are composed of various monomer building blocks. They are solid biopolymers which are incorporated into the plant cell wall. A substance is referred to as a derivative of a parent compound in the sense of the present disclosure if it has a structural unit which is similar to the functional group of the parent compound and contains a structural element of this functional group in the same oxidation state. It may be provided that the lignin derivative comprises a lignosulfonate. It may be provided that the lignin derivative is lignosulfonate. A corresponding exemplary lignin derivative is, for example, the commercially available product Starlig@Ca from LignoStar.

It may be provided that the polymer is comprised in the composition in an amount selected from the group consisting of at least 60% by weight, at least 65% by weight, at least 70% by weight, at least 75% by weight and at least 78% by weight, based on the total weight of the composition.

It may be provided that the polymer is comprised in the composition in an amount selected from the group consisting of at most 99.9% by weight, at most 99% by weight, at most 95% by weight, at most 92% by weight, at most 90% by weight, at most 87.5% by weight, at most 85% by weight and at most 82% by weight, based on the total weight of the composition.

It may be provided that the polymer is comprised in the composition in an amount selected from group consisting of 60 to 99% by weight, 65 to 95% by weight, 70 to 92% by weight, 75 to by weight, 78 to 82% by weight, for example about 80% by weight, based on the total weight of the composition.

It may be provided that the polymer is a thermoplastic polymer. The polymer may be selected from
homo- or copolymers which contain, in copolymerized form, at least one monomer which is selected from C₂-C₁₀ monoolefins, such as, for example, ethylene or propylene, 1,3-butadiene, 2-chloro-1,3-butadiene, vinyl alcohol and the C₂-C10 alkyl esters thereof, vinyl chloride, vinylidene chloride, vinylidene fluoride, tetrafluoroethylene, glycidyl acrylate, glycidyl methacrylate, acrylates and methacrylates with alcohol components of branched and unbranched C₁-C10 alcohols, vinylaromatics, such as, for example, styrene, (meth)acrylonitrile, α,β-ethylenically unsaturated mono- and dicarboxylic acids, and maleic anhydride;
homo- and copolymers of vinyl acetals;
polyvinyl esters;
polycarbonates (PC);
polyesters, such as polyalkylene terephthalates, polyhydroxyalkanoates (PHA), polybutylene succinates (PBS), polybutylene succinate adipates (PBSA);
polyethers;
polyether ketones;
thermoplastic polyurethanes (TPU);
polysulfides;
polysulfones;
natural rubber
   and mixtures thereof.

The inventors have recognized that, in particular, fractions of more than 15% by weight, based the total weight of the plastic composition, of elastomers, in particular of homo- and copolymers of vinyl acetate and/or ethylene, in particular of ethylene-vinyl acetate copolymers, have a negative effect on the mechanical properties of the plastic composition, in particular such a negative effect that the materials can no longer be used for producing extrusion profiles, at best as material for foaming extrusion profiles, such as door and window frame profiles.

Furthermore, elastomers, such as ethylene-vinyl acetate copolymers, are expensive. Accordingly, it may be provided that the plastic composition has a fraction of at most 15% by weight, preferably of at most 10% by weight, 5% by weight, 3% by weight, 1% by weight, 0.5% by weight, 0.1% by weight, is particularly preferably free of elastomers, in particular of homo- and copolymers of vinyl acetate and/or ethylene, for example of ethylene-vinyl acetate copolymers. Alternatively, or additionally, the plastic composition comprises a fraction of at most 0.5% by weight, 0.3% by weight, 0.1% by weight, 0.05% by weight, 0.01% by weight, is preferably free of foam stabilizers. It may be provided that the polymer comprises a halogen-containing polymer, in particular consists of at least 10% by weight, 20% by weight, 30% by weight, 40% by weight, 50% by weight, 60% by weight, 70% by weight, 80% by weight, 90% by weight, 95% by weight, 98% by weight, 99% by weight, 99.5% by weight, 99.9% by weight or 100% by weight thereof. In this context, a halogen-containing polymer is in particular a hydrocarbon-based polymer in which at least one hydrogen atom per monomer unit has been replaced by one of the halogens fluorine, chlorine, bromine or iodine. In the case of a copolymer, at least one hydrogen atom per comonomer unit of at least one of the comonomers has been replaced by one of the halogens fluorine, chlorine, bromine or iodine. It may be provided that the halogen-containing polymer comprises a chlorine-containing polymer, a fluorine-containing polymer or a chlorine- and fluorine-containing polymer, in particular consists of at least 10% by weight, 20% by weight, 30% by weight, 40% by weight, 50% by weight, 60% by weight, 70% by weight, 80% by weight, 90% by weight, 95% by weight, 98% by weight, 99% by weight, 99.5% by weight, 99.9% by weight or 100% by weight thereof. It may be provided that the halogen-containing polymer is selected, in particular at least 10% by weight, 20% by weight, 30% by weight, 40% by weight, 50% by weight, 60% by weight, 70% by weight, 80% by weight, 90% by weight, 95% by weight, 98% by weight, 99% by weight, 99.5% by weight, 99.9% by weight or 100% by weight thereof, from polyvinyl chloride, chlorinated polyethylene, polytetrafluoroethylene, polytrichlorofluoroethylene, polyvinylidene fluoride or mixtures of two or more thereof. It may be provided that the halogen-containing polymer comprises polyvinyl chloride, in particular at least 10% by weight, 20% by weight, 30% by weight, 40% by weight, 50% by weight, 60% by weight, 70% by weight, 80% by weight, 90% by weight, 95% by weight, 98% by weight, 99% by weight, 99.5% by weight, 99.9% by weight thereof. It may be provided that the halogen-containing polymer is polyvinyl chloride.

It may be provided that the halogen-containing polymer consists of at least one first polyvinyl chloride and of at least one second polyvinyl chloride. It may be provided that the halogen-containing polymer consists of a first polyvinyl chloride and of a second polyvinyl chloride. It may be provided that the first polyvinyl chloride and the second polyvinyl chloride are present in the halogen-containing polymer in a weight ratio selected from the group consisting of from 10:1 to 1:10, from 5:1 to 1:5 and from 2:1 to 1:2, in particular in a weight ratio of approximately 6:4.

It may be provided that the first polyvinyl chloride has a K value according to DIN EN ISO 1628-2 (in the version valid on the filing date) selected from the group consisting of from 60 to 70, from 65 to 69, from 65 to 68 and 67.5 to 68.5, in particular approximately 68. It may be provided that the first polyvinyl chloride has a bulk density according to DIN EN ISO 60 (in the version valid on the filing date) selected from the group consisting of from 0.4 to 0.8 g/cm³ and from 0.5 to 0.6 g/cm³, in particular approximately 0.57. It may be provided that the first polyvinyl chloride has a value of sieve analysis—residue on 0.063 mm sieve according to DIN EN ISO 4610 (in the version valid on the filing date) selected from the group consisting of at least 90% and at least 95%, in particular at least approximately 96%. It may be provided that the first polyvinyl chloride has a value of sieve analysis—residue on 0.250 mm sieve according to DIN EN ISO 4610 (in the version valid on the filing date) selected from the group consisting of at least 1% and at least 2%, in particular at least approximately 3%. It may be provided that the first polyvinyl chloride has a proportion of volatile constituents according to DIN EN ISO 1269 selected from the group consisting of at most 1% and at most 0.5%, in particular at most approximately 0.3%. It may be provided that the first polyvinyl chloride has a plasticizer absorption according to ISO 4608 (in the version valid on the filing date) selected from the group consisting of from 10 to 30%, from 15 to 25% and from 18 to 22%, in particular approximately 20%. A corresponding commercially available first polyvinyl chloride is, for example, Vynova S6830.

It may be provided that the second polyvinyl chloride has a K value according to DIN EN ISO 1628-2 (in the version valid on the filing date) selected from the group consisting of from 60 to 70, from 63 to 68, from 65 to 68, from 65 to 67 and from 65.5 to 66.5, in particular approximately 66. It may be provided that the second polyvinyl chloride has a bulk density according to DIN EN ISO 60 (in the version valid on the filing date) selected from the group consisting of from 0.4 to 0.8 g/cm³ and from 0.5 to 0.6 g/cm³, in particular approximately 0.56. It may be provided that the second polyvinyl chloride has a value of sieve analysis—residue on 0.063 mm sieve according to DIN EN ISO 4610 (in the version valid on the filing date) selected from the group consisting of at least 90% and at least 95%, in particular at least approximately 97%. It may be provided that the second polyvinyl chloride has a value of sieve analysis—residue on 0.200 mm sieve according to DIN EN ISO 4610 (in the version valid on the filing date) selected from the group consisting of at most 20% and at most 17%, in particular at most approximately 15%. It may be provided that the second polyvinyl chloride has a proportion of volatile constituents according to DIN EN ISO 1269 selected from the group consisting of at most 1% and at most 0.5%, in particular at most approximately 0.3%. A corresponding commercially available second polyvinyl chloride is, for example, Primex S 6658 from vestolit.

It may be provided that the composition further comprises a heat stabilizer.

Plastics are sensitive to the action of heat. Above a temperature characteristic for the material (decomposition temperature), the decomposition of the molecular structure sets in. Heat stabilizers serve to prevent this.

It may be provided that the heat stabilizer is comprised in the composition in an amount selected from the group consisting of at least 0.01% by weight, at least 0.05% by weight, at least 0.1% by weight, at least 0.2% by weight, at least 0.3% by weight, at least 0.4% by weight, at least 0.5% by weight, at least 0.6% by weight and at least 0.7% by weight, based on the total weight of the composition.

It may be provided that the heat stabilizer is comprised in the composition in an amount selected from the group consisting of at most 10% by weight, at most 7.5% by weight, at most 5% by weight, at most 2.5% by weight, at most 2% by weight, at most 1.5% by weight, at most 1.25% by weight, at most 1% by weight and at most 0.9% by weight, based on the total weight of the composition.

It may be provided that the heat stabilizer is comprised in the composition in an amount selected from the group consisting of 0.01 to 10% by weight, 0.1 to 7.5% by weight, 0.2 to 5% by weight, 0.3 to 2.5% by weight, 0.4 to 2% by weight, 0.5 to 1.5% by weight, 0.6 to 1.25% by weight and 0.7 to 0.9% by weight, for example about 0.8% by weight, based on the total weight of the composition.

It may be provided that the heat stabilizer comprises an organic barium, zinc, tin and cadmium compound and/or an inorganic lead salt. It may be provided that the heat stabilizer comprises an organic barium compound and/or an organic cadmium compound. It may be provided that the heat stabilizer comprises an organic barium compound and an organic cadmium compound.

It may be provided that the heat stabilizer comprises zinc stearate, calcium stearate or a mixture thereof. It may be provided that the heat stabilizer comprises a mixture of zinc stearate and calcium stearate in a weight ratio of 1:1 to 5:1 in an amount of at least 90% by weight, based on the total weight of the heat stabilizer. It may be provided that the heat stabilizer consists of a mixture of zinc stearate and calcium stearate in a weight ratio of 1:1 to 5:1. It may be provided that the heat stabilizer consists of a mixture of zinc stearate and calcium stearate in a weight ratio of 2:1 to 3:1. A corresponding exemplary zinc stearate is, for example, the commercially available product Ligastar Zn 101/6. A corresponding exemplary calcium stearate is, for example, the commercially available product Ligastar CA 600.

It may be provided that the zinc stearate is comprised in the composition in an amount selected from the group consisting of 0.05 to 5.0% by weight, 0.1 to 2.0% by weight, 0.2 to 1.0% by weight, 0.3 to 1.0% by weight, 0.4 to 0.8% by weight and 0.5 to 0.6% by weight, for example about 0.55% by weight, based on the total weight of the composition and/or that the calcium stearate is comprised in the composition in an amount selected from the group consisting of 0.01 to 2.5% by weight, 0.05 to 1.0% by weight, 0.1 to 1.0% by weight, 0.15 to 0.5% by weight and 0.2 to 0.3% by weight, for example about 0.24% by weight, based on the total weight of the composition.

It may be provided that the zinc stearate is comprised in the composition in an amount selected from the group consisting of 0.05 to 5.0% by weight, 0.1 to 2.0% by weight, 0.2 to 1.0% by weight, 0.3 to 1.0% by weight, 0.4 to 0.8% by weight and 0.5 to 0.6% by weight, for example about 0.55% by weight, based on the total weight of the composition and/or that the calcium stearate is comprised in the composition in an amount selected from the group consisting of 0.01 to 2.5% by weight, 0.05 to 1.0% by weight, 0.1 to 1.0% by weight, 0.15 to 0.5% by weight and 0.2 to 0.3% by weight, for example about 0.24% by weight, based on the total weight of the composition.

It may be provided that the composition further comprises a co-stabilizer.

It may be provided that the co-stabilizer is comprised in the composition in an amount selected from the group consisting of at least 0.01% by weight, at least 0.05% by weight, at least 0.1% by weight, at least 0.2% by weight, at least 0.3% by weight and at least 0.4% by weight, based on the total weight of the composition.

It may be provided that the co-stabilizer is comprised in the composition in an amount selected from the group consisting of at most 5% by weight, at most 4% by weight, at most 3% by weight, at most 2% by weight, at most 1% by weight and at most 0.5% by weight, based on the total weight of the composition.

It may be provided that the co-stabilizer is comprised in the composition in an amount selected from the group consisting of 0.01 to 5% by weight, 0.05 to 4% by weight, 0.1 to 3% by weight, 0.2 to 2% by weight, 0.3 to 1% by weight and 0.3 to 0.5% by weight, for example about 0.4% by weight, based on the total weight of the composition.

It may be provided that the co-stabilizer comprises a nucleophilic compound, an antioxidant, an acid scavenger or a mixture of two or more thereof. It may be provided that the co-stabilizer comprises a mixture of at least one nucleophilic compound, at least one antioxidant and at least one acid scavenger.

It may be provided that the nucleophilic compound comprises an organic compound having two or more, preferably three, hydroxyl groups, for example tris(2-hydroxyethyl)isocyanurate, β-diketone. It may be provided that the nucleophilic compound comprises, or consists of, tris(2-hydroxyethyl)isocyanurate, β-diketone, calcium acetylacetonate or a mixture of two or more thereof. It may be provided that the nucleophilic compound comprises, or consists of, a mixture of tris(2-hydroxyethyl)isocyanurate, β-diketone and calcium acetylacetonate.

It may be provided that the calcium acetylacetonate is comprised in the composition in an amount selected from the group consisting of 0.01 to 2.0% by weight, 0.02 to 1.0% by weight, 0.03 to 0.6% by weight, 0.04 to 0.3% by weight, 0.05 to 0.2% by weight and 0.06 to 0.1% by weight, for example about 0.07% by weight, based on the total weight of the composition.

It may be provided that the tris(2-hydroxyethyl)isocyanurate is comprised in the composition in an amount selected from the group consisting of 0.01 to 5.0% by weight, 0.03 to 2.0% by weight, 0.05 to 1.0% by weight, 0.08 to 0.7% by weight, 0.1 to 0.5% by weight and 0.12 to 0.2% by weight, for example about 0.14% by weight, based on the total weight of the composition.

It may be provided that the sodium aluminosilicate is comprised in the composition in an amount selected from the group consisting of 0.01 to 2.0% by weight, 0.01 to 1.0% by weight, 0.02 to 0.6% by weight, 0.03 to 0.3% by weight, 0.04 to 0.2% by weight and 0.05 to 0.1% by weight, for example about 0.06% by weight, based on the total weight of the composition.

It may be provided that the β-diketone is comprised in the composition in an amount selected from the group consisting of 0.01 to 2.0% by weight, 0.02 to 1.0% by weight, 0.03 to 0.6% by weight, 0.05 to 0.3% by weight, 0.06 to 0.2% by weight and 0.07 to 0.1% by weight, for example about 0.08% by weight, based on the total weight of the composition.

It may be provided that the antioxidant is a sterically hindered phenolic compound, for example octadecyl-[3-(3,5-di-tert-butyl-4-hydroxyphenyl)propionate], which is commercially available as Irganox 1076.

It may be provided that the antioxidant, in particular the sterically hindered phenolic compound, preferably octadecyl-[3-(3,5-di-tert-butyl-4-hydroxyphenyl)propionate], is comprised in the composition in an amount selected from the group consisting of 0.01 to 2.0% by weight, 0.02 to 1.0% by weight, 0.03 to 0.6% by weight, 0.04 to 0.3% by weight, 0.05 to 0.2% by weight and 0.06 to 0.1% by weight, for example about 0.07% by weight, based on the total weight of the composition.

It may be provided that the acid scavenger comprises, or consists of, hydrotalcite, zeolite or a mixture of two or more thereof, preferably comprises, or consists of, a mixture of hydrotalcite and zeolite.

It may be provided that the composition further comprises a lubricant.

It may be provided that the lubricant is comprised in the composition in an amount selected from the group consisting of at least 0.01% by weight, at least 0.05% by weight, at least 0.1% by weight, at least 0.3% by weight, at least 0.5% by weight and at least 0.7% by weight, based on the total weight of the composition.

It may be provided that the lubricant is comprised in the composition in an amount selected from the group consisting of at most 5% by weight, at most 4% by weight, at most 3% by weight, at most 2% by weight, at most 1% by weight and at most 0.8% by weight, based on the total weight of the composition.

It may be provided that the lubricant is comprised in the composition in an amount selected from the group consisting of 0.01 to 5% by weight, 0.05 to 4% by weight, 0.1 to 3% by weight, 0.2 to 2% by weight, 0.4 to 1% by weight and 0.6 to 0.9% by weight, for example about 0.75% by weight, based on the total weight of the composition.

It may be provided that the lubricant comprises (or consists of) at least one selected from the group consisting of a fatty acid, in particular 12-hydroxystearic acid, an oil, in particular hydrogenated castor oil, a wax, in particular low density polyethylene (LDPE) wax, a paraffin, in particular Fischer-Tropsch paraffin, oxidized polyethylenes, complex esters and a mixture of two or more thereof. It may be provided that the lubricant comprises a mixture of 12-hydroxystearic acid, hydrogenated castor oil, low density polyethylene (LDPE) wax, Fischer-Tropsch paraffin and oxidized polyethylenes. It may be provided that the lubricant consists of a mixture of 12-hydroxystearic acid, hydrogenated castor oil, low density polyethylene (LDPE) wax, Fischer-Tropsch paraffin and oxidized polyethylenes.

It may be provided that the 12-hydroxystearic acid is comprised in the composition in an amount selected from the group consisting of 0.01 to 2.5% by weight, 0.05 to 1.5% by weight, 0.1 to 1.0% by weight, 0.2 to 0.7% by weight, 0.3 to 0.5% by weight and 0.2 to 0.4% by weight, for example about 0.3% by weight, based on the total weight of the composition.

It may be provided that the hydrogenated castor oil is comprised in the composition in an amount selected from the group consisting of 0.01 to 2.0% by weight, 0.05 to 1.0% by weight, 0.08 to 0.6% by weight, 0.1 to 0.4% by weight, 0.12 to 0.3% by weight and 0.14 to 0.2% by weight, for example about 0.16% by weight, based on the total weight of the composition.

It may be provided that the low density polyethylene (LDPE) wax is comprised in the composition in an amount selected from the group consisting of 0.01 to 2.0% by weight, 0.05 to 1.0% by weight, 0.08 to 0.6% by weight, 0.1 to 0.4% by weight, 0.15 to 0.3% by weight and 0.18 to 0.25% by weight, for example about 0.2% by weight, based on the total weight of the composition.

It may be provided that the Fischer-Tropsch paraffin is comprised in the composition in an amount selected from the group consisting of 0.01 to 2.0% by weight, 0.02 to 1.0% by weight, 0.03 to 0.6% by weight, 0.04 to 0.3% by weight, 0.05 to 0.2% by weight and 0.06 to 0.1% by weight, for example about 0.07% by weight, based on the total weight of the composition.

It may be provided that the oxidized polyethylenes is comprised in the composition in an amount selected from the group consisting of 0.01 to 2.0% by weight, 0.01 to 1.0% by weight, 0.02 to 0.6% by weight, 0.03 to 0.3% by weight, 0.04 to 0.2% by weight and 0.05 to 0.1% by weight, for example about 0.06% by weight, based on the total weight of the composition.

It may be provided that the composition further comprises a flow agent.

It may be provided that the flow agent is comprised in the composition in an amount selected from the group consisting of at least 1% by weight, at least 2% by weight, at least 3% by weight and at least 4% by weight, based on the total weight of the composition.

It may be provided that the flow agent is comprised in the composition in an amount selected from the group consisting of at most 10% by weight, at most 9% by weight, at most 8% by weight, at most 7% by weight, at most 6% by weight and at most 5% by weight, based on the total weight of the composition.

It may be provided that the flow agent is comprised in the composition in an amount selected from the group consisting of 1 to 10% by weight, 2 to 9% by weight, 3 to 8% by weight and 4 to 6% by weight, based on the total weight of the composition.

It may be provided that the flow agent comprises or consists of acrylic-based or (meth)acrylic-based particles, in particular comprises acrylic-based or (meth)acrylic-based particles having a median particle size in a range from 50 to 300 μm. A corresponding commercially available product is, for example, Paraloid K125.

It may be provided that the composition further comprises an impact strength modifier.

It may be provided that the impact strength modifier is comprised in the composition in an amount selected from the group consisting of at least 1% by weight, at least 2% by weight, at least 3% by weight and at least 4% by weight, based on the total weight of the composition.

It may be provided that the impact strength modifier is comprised in the composition in an amount selected from the group consisting of at most 10% by weight, at most 9% by weight, at most 8% by weight, at most 7% by weight, at most 6% by weight and at most 5% by weight, based on the total weight of the composition.

It may be provided that the impact strength modifier is comprised in the composition in an amount selected from the group consisting of 1 to 10% by weight, 2 to 9% by weight, 3 to 8% by weight and 4 to 6% by weight, based on the total weight of the composition.

It may be provided that the impact strength modifier is an acrylic polymer, for example an acrylic polymer having a D50 particle size of 200 μm and/or a bulk density of 0.4 to 0.5 g/cm³. A corresponding commercially available product is, for example, Kaneka FM 56 K3.

It may be provided that the composition further comprises CaCO₃, in particular as an agent for improving the mechanical properties of a product obtained by means of the composition. Suitable commercially available products are, for example, Precarb 400 or Microcarb 95T.

It may be provided that the CaCO₃ is comprised in the composition in an amount selected from the group consisting of at least 1% by weight, at least 3% by weight, at least 4% by weight and at least 5% by weight and at least 6% by weight, based on the total weight of the composition.

It may be provided that the CaCO₃ is comprised in the composition in an amount selected from the group consisting of at most 15% by weight, at most 12.5% by weight, at most 10% by weight, at most 8% by weight and at most 7% by weight, based on the total weight of the composition.

It may be provided that the CaCO₃ is comprised in the composition in an amount selected from the group consisting of 1 to 15% by weight, 3 to 10% by weight, 4 to 8% by weight and 6 to 7% by weight, based on the total weight of the composition.

It may be provided that the composition further comprises an adhesion promoter.

It may be provided that the adhesion promoter is comprised in the composition in an amount selected from the group consisting of at least 0.01% by weight, at least 0.04% by weight, at least 0.08% by weight and at least 0.16% by weight, based on the total weight of the composition.

It may be provided that the adhesion promoter is comprised in the composition in an amount selected from the group consisting of at most 5% by weight, at most 1.6% by weight, at most 0.8% by weight and at most 0.4% by weight, based on the total weight of the composition.

It may be provided that the adhesion promoter is comprised in the composition in an amount selected from the group consisting of 0.01 to 5% by weight, 0.04 to 1.6% by weight, 0.08 to 0.8% by weight, 0.16 to 0.4% by weight, based on the total weight of the composition.

Adhesion promoters according to the present disclosure are substances which produce a tight physical or usually chemical bond in the interface of immiscible substances. It may be provided that the adhesion promoter is a modified polyolefin, in particular a polyolefin modified with chlorine and/or maleic anhydride. It may be provided that the adhesion promoter is maleic acid-grafted polyethylenes or consists thereof. A corresponding commercially available adhesion promoter is, for example, Licocene PE MA 4221.

It may be provided that the composition further comprises a colorant.

It may be provided that the colorant is comprised in the composition in an amount selected from the group consisting of at least 1% by weight, at least 2% by weight and at least 3% by weight, based on the total weight of the composition.

It may be provided that the colorant is comprised in the composition in an amount selected from the group consisting of at most 8% by weight, at most 7% by weight, at most 6% by weight and at most 5% by weight, based on the total weight of the composition.

It may be provided that the colorant is comprised in the composition in an amount selected from the group consisting of 1 to 8% by weight, 2 to 6% by weight and 3 to 5% by weight, for example about 4% by weight, based on the total weight of the composition.

It may be provided that the colorant is selected from the group consisting of TiO2 pigment, blue pigment, violet pigment and a mixture of two or more thereof, in particular comprises a mixture of TiO2 pigment, blue pigment and violet pigment. Corresponding commercially available products are, for example, TiO₂ RFK-3, pigment blue and pigment violet.

It may be provided that the composition further comprises Mg(OH)₂, in particular as an agent for improving the thermostability determined by dehydrochlorination. A corresponding commercially available product is, for example, Luvomaag H002.

It may be provided that the Mg(OH)₂ is comprised in the composition in an amount selected from the group consisting of at least 0.01% by weight, at least 0.04% by weight, at least 0.08% by weight and at least 0.16% by weight, based on the total weight of the composition.

It may be provided that the Mg(OH)₂ is comprised in the composition in an amount selected from the group consisting of at most 5% by weight, at most 1.6% by weight, at most 0.8% by weight and at most 0.4% by weight, based on the total weight of the composition.

It may be provided that the Mg(OH)₂ is comprised in the composition in an amount selected from the group consisting of 0.01 to 5% by weight, 0.04 to 1.6% by weight, 0.08 to 0.8% by weight, 0.16 to 0.4% by weight, based on the total weight of the composition.

According to a third aspect of the disclosure, a composition for producing extrusion profiles, in particular extruded window frame profiles or tubular profiles, is provided, comprising:
a polysaccharide, a lignin derivative or a mixture of two or more thereof;
a polymer; and
a heat stabilizer, wherein the heat stabilizer comprises a mixture of zinc stearate and calcium stearate;
   each based on the total weight of the composition.

It may be provided that the polysaccharide, the lignose derivative or the mixture of two or more thereof is comprised in the composition in an amount selected from the group consisting of at least 0.5% by weight, at least 1% by weight, at least 1.5% by weight, at least 2.0% by weight, at least 2.5% by weight, at least 3.0% by weight, at least 4.0% by weight, at least 5.0% by weight, at least 6.0% by weight, at least 7.0% by weight or at least 8.0% by weight, based on the total weight of the composition.

It may be provided that the polysaccharide, the lignose derivative or the mixture of two or more thereof is comprised in the composition in an amount selected from the group consisting of at most 40% by weight, at most 30% by weight, at most 20% by weight, at most 15% by weight, at most 10% by weight or at most 9% by weight, at most 6% by weight, at most 4% by weight and at most 3.5% by weight, based on the total weight of the composition.

It may be provided that the polysaccharide, the lignose derivative or the mixture of two or more thereof is comprised in the composition in an amount selected from the group consisting of 0.5 to 40% by weight, 1 to 30% by weight, 1.5 to 20% by weight, 2 to 15% by weight and 2.5 to 10% by weight, for example about 3% by weight, based on the total weight of the composition.

Polysaccharides in the sense of the present disclosure are carbohydrates in which a large number (at least eleven) monosaccharides (simple sugars) are linked via a glycosidic bond. It may be provided that the polysaccharide is selected from the group consisting of glycogen, starch (amylose and amylopectin), pectins, chitin, callose and cellulose. It may be provided that the polysaccharide comprises cellulose. It may be provided that the polysaccharide is cellulose. In particular if the polysaccharide comprises cellulose or is cellulose, it may be provided that the cellulose is comprised in the composition in an amount of at least 2.4% by weight, preferably at least 4% by weight, particularly preferably at least 5.6% by weight or 8% by weight, parts by weight based on the total weight of the composition. A corresponding exemplary cellulose is, for example, the commercially available product Cellulose Arbocell FD 600-30.

Lignins form a group of phenolic macromolecules which are composed of various monomer building blocks. They are solid biopolymers which are incorporated into the plant cell wall. A substance is referred to as a derivative of a parent compound in the sense of the present disclosure if it has a structural unit which is similar to the functional group of the parent compound and contains a structural element of this functional group in the same oxidation state. It may be provided that the lignin derivative comprises a lignosulfonate. It may be provided that the lignin derivative is lignosulfonate. A corresponding exemplary lignin derivative is, for example, the commercially available product Starlig®Ca from LignoStar.

It may be provided that the polymer is comprised in the composition in an amount selected from the group consisting of at least 20% by weight, at least 30% by weight, at least 40% by weight, at least 50% by weight, at least 55% by weight, at least 60% by weight, at least 70% by weight, at least 75% by weight and at least 78% by weight, based on the total weight of the composition. It may be provided that the polymer is comprised in the composition in an amount selected from the group consisting of at most 99% by weight, at most 95% by weight, at most 92% by weight, at most 90% by weight, at most 87.5% by weight, at most 85% by weight and at most 82% by weight, based on the total weight of the composition.

It may be provided that the polymer is comprised in the composition in an amount selected from the group consisting of 20 to 99% by weight, 30 to 95% by weight, 40 to 92% by weight, 50 to 90% by weight, 60 to 87.5% by weight, 75 to 85% by weight and 78 to 82% by weight, for example about 80% by weight, based on the total weight of the composition.

It may be provided that the polymer is a thermoplastic polymer. The polymer may be selected from
homo- or copolymers which contain, in copolymerized form, at least one monomer which is selected from C₂-C₁₀ monoolefins, such as, for example, ethylene or propylene, 1,3-butadiene, 2-chloro-1,3-butadiene, vinyl alcohol and the C₂-C₁₀ alkyl esters thereof, vinyl chloride, vinylidene chloride, vinylidene fluoride, tetrafluoroethylene, glycidyl acrylate, glycidyl methacrylate, acrylates and methacrylates with alcohol components of branched and unbranched C₁-C10 alcohols, vinylaromatics, such as, for example, styrene, (meth)acrylonitrile, α,β-ethylenically unsaturated mono- and dicarboxylic acids, and maleic anhydride;
homo- and copolymers of vinyl acetals;
polyvinyl esters;
polycarbonates (PC);
polyesters, such as polyalkylene terephthalates, polyhydroxyalkanoates (PHA), polybutylene succinates (PBS), polybutylene succinate adipates (PBSA);
polyethers;
polyether ketones;
thermoplastic polyurethanes (TPU);
polysulfides;
polysulfones;
natural rubber
   and mixtures thereof.

The inventors have recognized that, in particular, fractions of more than 15% by weight, based on the total weight of the plastic composition, of elastomers, in particular of homo- and copolymers of vinyl acetate and/or ethylene, in particular of ethylene-vinyl acetate copolymers, have a negative effect on the mechanical properties of the plastic composition, in particular such a negative effect that the materials can no longer be used for producing extrusion profiles, but at best as material for foaming extrusion profiles, such as door and window frame profiles. Furthermore, elastomers, such as ethylene-vinyl acetate copolymers, are expensive. Accordingly, it may be provided that the plastic composition has a fraction of at most 15% by weight, preferably of at most 10% by weight, 5% by weight, 3% by weight, 1% by weight, 0.5% by weight, 0.1% by weight, is particularly preferably free of elastomers, in particular of homo- and copolymers of vinyl acetate and/or ethylene, for example of ethylene-vinyl acetate copolymers. Alternatively, or additionally, the plastic composition comprises a fraction of at most 0.5% by weight, 0.3% by weight, 0.1% by weight, 0.05% by weight, 0.01% by weight, is preferably free of foam stabilizers.

It may be provided that the polymer comprises a halogen-containing polymer, in particular consists of at least 10% by weight, 20% by weight, 30% by weight, 40% by weight, 50% by weight, 60% by weight, 70% by weight, 80% by weight, 90% by weight, 95% by weight, 98% by weight, 99% by weight, 99.5% by weight, 99.9% by weight or 100% by weight thereof. In this context, a halogen-containing polymer is in particular a hydrocarbon-based polymer in which at least one hydrogen atom per monomer unit has been replaced by one of the halogens fluorine, chlorine, bromine or iodine. In the case of a copolymer, at least one hydrogen atom per comonomer unit of at least one of the comonomers has been replaced by one of the halogens fluorine, chlorine, bromine or iodine. It may be provided that the halogen-containing polymer comprises a chlorine-containing polymer, a fluorine-containing polymer or a chlorine- and fluorine-containing polymer, in particular consists of at least 10% by weight, 20% by weight, 30% by weight, 40% by weight, 50% by weight, 60% by weight, 70% by weight, 80% by weight, 90% by weight, 95% by weight, 98% by weight, 99% by weight, 99.5% by weight, 99.9% by weight or 100% by weight thereof. It may be provided that the halogen-containing polymer is selected, in particular at least 10% by weight, 20% by weight, 30% by weight, 40% by weight, 50% by weight, 60% by weight, 70% by weight, 80% by weight, 90% by weight, 95% by weight, 98% by weight, 99% by weight, 99.5% by weight, 99.9% by weight or 100% by weight thereof, from polyvinyl chloride, chlorinated polyethylene, polytetrafluoroethylene, polytrichlorofluoroethylene, polyvinylidene fluoride or mixtures of two or more thereof. It may be provided that the halogen-containing polymer comprises polyvinyl chloride, in particular at least 10% by weight, 20% by weight, 30% by weight, 40% by weight, 50% by weight, 60% by weight, 70% by weight, 80% by weight, 90% by weight, 95% by weight, 98% by weight, 99% by weight, 99.5% by weight, 99.9% by weight thereof. It may be provided that the halogen-containing polymer is polyvinyl chloride.

It may be provided that the halogen-containing polymer consists of at least one first polyvinyl chloride and of at least one second polyvinyl chloride. It may be provided that the halogen-containing polymer consists of a first polyvinyl chloride and of a second polyvinyl chloride. It may be provided that the first polyvinyl chloride and the second polyvinyl chloride are present in the halogen-containing polymer in a weight ratio selected from the group consisting of from 10:1 to 1:10, from 5:1 to 1:5 and from 2:1 to 1:2, in particular in a weight ratio of approximately 6:4.

In particular in the case of polyvinyl chloride, hydrogen chloride can be released by decomposition, for example by dehydrochlorination. Inter alia, the decomposition can be initiated and/or accelerated by heating. Released hydrogen chloride can catalyze the decomposition of the PVC by releasing further hydrogen chloride. The release of the hydrogen chloride can thus take place autocatalytically. This may have the consequence that the decomposition of the PVC is accelerated and is initiated at lower temperatures. As a result of the autocatalysis, the decomposition can also be more difficult to control as a self-reinforcing process.

The decomposition of PVC can also be reinforced by labile chlorine atoms. These labile chlorine atoms can more easily detach from the polymer chain and/or form hydrogen chloride. In particular, the labile chlorine atoms can be found at defect sites which can be produced in particular by dehydrochlorination.

Stabilization of the PVC can therefore take place by reducing and/or preventing the release of the hydrogen chloride, and/or by sequestering the hydrogen chloride. Thus, stabilization of the PVC can take place by substituting labile chlorine atoms by more strongly bonded substituents. The stabilization of the PVC takes place in particular by substituting labile chlorine atoms at double bonds (“allyl chlorides”) by the zinc stearate and/or sequestering hydrogen chlorides by the zinc stearate and/or the calcium stearate.

The sequestering takes place in particular by reacting the hydrogen chloride with zinc stearate and/or with calcium stearate to form stearic acid and zinc chloride and/or calcium chloride. The substitution of labile chlorine atoms can take place at a defect position of the PVC. As a result of the substitution, chlorine at the defect position is replaced by a more stable substituent and can thereby be rendered inert. At the same time, the thermostability of the PVC can thereby be improved. The substitution takes place in particular by substituting chlorine by stearate, in particular by the stearate being bonded to the PVC by its carboxylate group, preferably being bonded via an ester bond. In particular, chlorine, which is substituted, is bonded by a metal, in particular by zinc, thereby forming a metal chloride.

The inventors were able to observe a synergistic effect as a result of an interaction between zinc stearate and calcium stearate. Without being bound to an explanation, zinc chloride, which can be formed during the substitution and sequestering, reacts with calcium stearate, as a result of which zinc stearate and calcium chloride are formed. In particular, the zinc stearate compound of the heat stabilizer can be reactivated as a result of this reaction.

Without wishing to be bound to this explanation, the synergistic effect appears to be reinforced by the following mechanisms. The reactivation of the zinc stearate as a result of the reaction of the calcium stearate with zinc chloride has a first chemical equilibrium with a first equilibrium constant. At the same time, there is a second chemical equilibrium with a second equilibrium constant as a result of the substitution reaction, in which a labile chlorine atom of the PVC can be substituted by the zinc stearate. As a result of the reactivation of the zinc stearate, it is thus possible to control the second chemical equilibrium as a result of the concentration of the reactants of the first chemical equilibrium, for example as a result of the calcium stearate concentration. The efficiency and/or the degree of substitution of the labile chlorine atoms of the PVC can thus be increased by targeted use of calcium stearate concentration.

It may be provided that the first polyvinyl chloride has a K value according to DIN EN ISO 1628-2 (in the version valid on the filing date) selected from the group consisting of from 60 to 70, from 65 to 69, from 65 to 68 and 67.5 to 68.5, in particular approximately 68. It may be provided that the first polyvinyl chloride has a bulk density according to DIN EN ISO 60 (in the version valid on the filing date) selected from the group consisting of from 0.4 to 0.8 g/cm³ and from 0.5 to 0.6 g/cm³, in particular approximately 0.57. It may be provided that the first polyvinyl chloride has a value of sieve analysis—residue on 0.063 mm sieve according to DIN EN ISO 4610 (in the version valid on the filing date) selected from the group consisting of at least 90% and at least 95%, in particular at least approximately 96%. It may be provided that the first polyvinyl chloride has a value of sieve analysis—residue on 0.250 mm sieve according to DIN EN ISO 4610 (in the version valid on the filing date) selected from the group consisting of at least 1% and at least 2%, in particular at least approximately 3%. It may be provided that the first polyvinyl chloride has a proportion of volatile constituents according to DIN EN ISO 1269 selected from the group consisting of at most 1% and at most 0.5%, in particular at most approximately 0.3%. It may be provided that the first polyvinyl chloride has a plasticizer absorption according to ISO 4608 (in the version valid on the filing date) selected from the group consisting of from 10 to 30%, from 15 to 25% and from 18 to 22%, in particular approximately 20%. A corresponding commercially available first polyvinyl chloride is, for example, Vynova S6830.

It may be provided that the second polyvinyl chloride has a K value according to DIN EN ISO 1628-2 (in the version valid on the filing date) selected from the group consisting of from 60 to 70, from 63 to 68, from 65 to 68, from 65 to 67 and from 65.5 to 66.5, in particular approximately 66. It may be provided that the second polyvinyl chloride has a bulk density according to DIN EN ISO 60 (in the version valid on the filing date) selected from the group consisting of from 0.4 to 0.8 g/cm³ and from 0.5 to 0.6 g/cm³, in particular approximately 0.56. It may be provided that the second polyvinyl chloride has a value of sieve analysis—residue on 0.063 mm sieve according to DIN EN ISO 4610 (in the version valid on the filing date) selected from the group consisting of at least 90% and at least 95%, in particular at least approximately 97%. It may be provided that the second polyvinyl chloride has a value of sieve analysis—residue on 0.200 mm sieve according to DIN EN ISO 4610 (in the version valid on the filing date) selected from the group consisting of at most 20% and at most 17%, in particular at most approximately 15%. It may be provided that the second polyvinyl chloride has a proportion of volatile constituents according to DIN EN ISO 1269 selected from the group consisting of at most 1% and at most 0.5%, in particular at most approximately 0.3%. A corresponding commercially available second polyvinyl chloride is, for example, Primex S 6658 from vestolit. It may be provided that the heat stabilizer is comprised in the composition in an amount selected from the group consisting of at least 0.01% by weight, at least 0.05% by weight, at least 0.1% by weight, at least 0.2% by weight, at least 0.3% by weight, at least 0.4% by weight, at least 0.5% by weight, at least 0.6% by weight and at least 0.7% by weight, based on the total weight of the composition.

It may be provided that the heat stabilizer is comprised in the composition in an amount selected from the group consisting of at most 10% by weight, at most 7.5% by weight, at most 5% by weight, at most 2.5% by weight, at most 2% by weight, at most 1.5% by weight, at most 1.25% by weight, at most 1% by weight and at most 0.9% by weight, based on the total weight of the composition.

It may be provided that the heat stabilizer is comprised in the composition in an amount selected from the group consisting of 0.01 to 10% by weight, 0.1 to 7.5% by weight, 0.2 to 5% by weight, 0.3 to 2.5% by weight, 0.4 to 2% by weight, 0.5 to 1.5% by weight, 0.6 to 1.25% by weight and 0.7 to 0.9% by weight, for example about 0.8% by weight, based on the total weight of the composition.

It may be provided that the heat stabilizer comprises a mixture of zinc stearate and calcium stearate in a weight ratio of 1:1 to 5:1 in an amount of at least 90% by weight, based on the total weight of the heat stabilizer. It may be provided that the heat stabilizer consists of a mixture of zinc stearate and calcium stearate in a weight ratio of 1:1 to 5:1. It may be provided that the heat stabilizer consists of a mixture of zinc stearate and calcium stearate in a weight ratio of 2:1 to 3:1. A corresponding exemplary zinc stearate is, for example, the commercially available product Ligastar Zn 101/6. A corresponding exemplary calcium stearate is, for example, the commercially available product Ligastar CA 600.

It may be provided that the composition further comprises a co-stabilizer.

It may be provided that the co-stabilizer is comprised in the composition in an amount selected from the group consisting of at least 0.01% by weight, at least 0.05% by weight, at least 0.1% by weight, at least 0.2% by weight, at least 0.3% by weight and at least 0.4% by weight, based on the total weight of the composition.

It may be provided that the co-stabilizer is comprised in the composition in an amount selected from the group consisting of at most 5% by weight, at most 4% by weight, at most 3% by weight, at most 2% by weight, at most 1% by weight and at most 0.5% by weight, based on the total weight of the composition.

It may be provided that the co-stabilizer is comprised in the composition in an amount selected from the group consisting of 0.01 to 5% by weight, 0.05 to 4% by weight, 0.1 to 3% by weight, 0.2 to 2% by weight, 0.3 to 1% by weight and 0.3 to 0.5% by weight, for example about 0.4% by weight, based on the total weight of the composition.

It may be provided that the co-stabilizer comprises a nucleophilic compound, an antioxidant, an acid scavenger or a mixture of two or more thereof. It may be provided that the co-stabilizer comprises a mixture of at least one nucleophilic compound, at least one antioxidant and at least one acid scavenger.

It may be provided that the nucleophilic compound comprises an organic compound having two or more, preferably three, hydroxyl groups, for example tris(2-hydroxyethyl)isocyanurate, β-diketone. It may be provided that the nucleophilic compound comprises, or consists of, tris(2-hydroxyethyl)isocyanurate, β-diketone, calcium acetylacetonate or a mixture of two or more thereof. It may be provided that the nucleophilic compound comprises, or consists of, a mixture of tris(2-hydroxyethyl)isocyanurate, β-diketone and calcium acetylacetonate.

It may be provided that the calcium acetylacetonate is comprised in the composition in an amount selected from the group consisting of 0.01 to 2.0% by weight, 0.02 to 1.0% by weight, 0.03 to 0.6% by weight, 0.04 to 0.3% by weight, 0.05 to 0.2% by weight and 0.06 to 0.1% by weight, for example about 0.07% by weight, based on the total weight of the composition.

It may be provided that the tris(2-hydroxyethyl)isocyanurate is comprised in the composition in an amount selected from the group consisting of 0.01 to 5.0% by weight, 0.03 to 2.0% by weight, 0.05 to 1.0% by weight, 0.08 to 0.7% by weight, 0.1 to 0.5% by weight and 0.12 to 0.2% by weight, for example about 0.14% by weight, based on the total weight of the composition.

It may be provided that the sodium aluminosilicate is comprised in the composition in an amount selected from the group consisting of 0.01 to 2.0% by weight, 0.01 to 1.0% by weight, 0.02 to 0.6% by weight, 0.03 to 0.3% by weight, 0.04 to 0.2% by weight and 0.05 to 0.1% by weight, for example about 0.06% by weight, based on the total weight of the composition.

It may be provided that the β-diketone is comprised in the composition in an amount selected from the group consisting of 0.01 to 2.0% by weight, 0.02 to 1.0% by weight, 0.03 to 0.6% by weight, 0.05 to 0.3% by weight, 0.06 to 0.2% by weight and 0.07 to 0.1% by weight, for example about 0.08% by weight, based on the total weight of the composition.

It may be provided that the antioxidant is a sterically hindered phenolic compound, for example octadecyl-[3-(3,5-di-tert-butyl-4-hydroxyphenyl)propionate], which is commercially available as Irganox 1076.

It may be provided that the antioxidant, in particular the sterically hindered phenolic compound, preferably octadecyl-[3-(3,5-di-tert-butyl-4-hydroxyphenyl)propionate], is comprised in the composition in an amount selected from the group consisting of 0.01 to 2.0% by weight, 0.02 to 1.0% by weight, 0.03 to 0.6% by weight, 0.04 to 0.3% by weight, 0.05 to 0.2% by weight and 0.06 to 0.1% by weight, for example about 0.07% by weight, based on the total weight of the composition.

It may be provided that the acid scavenger comprises, or consists of, hydrotalcite, zeolite or a mixture of two or more thereof, preferably comprises, or consists of, a mixture of hydrotalcite and zeolite.

It may be provided that the composition further comprises a lubricant.

It may be provided that the lubricant is comprised in the composition in an amount selected from the group consisting of at least 0.01% by weight, at least 0.05% by weight, at least 0.1% by weight, at least 0.3% by weight, at least 0.5% by weight and at least 0.7% by weight, based on the total weight of the composition.

It may be provided that the lubricant is comprised in the composition in an amount selected from the group consisting of at most 5% by weight, at most 4% by weight, at most 3% by weight, at most 2% by weight, at most 1% by weight and at most 0.8% by weight, based on the total weight of the composition.

It may be provided that the lubricant is comprised in the composition in an amount selected from the group consisting of 0.01 to 5% by weight, 0.05 to 4% by weight, 0.1 to 3% by weight, 0.2 to 2% by weight, 0.4 to 1% by weight and 0.6 to 0.9% by weight, for example about 0.75% by weight, based on the total weight of the composition.

It may be provided that the lubricant comprises (or consists of) at least one selected from the group consisting of a fatty acid, in particular 12-hydroxystearic acid, an oil, in particular hydrogenated castor oil, a wax, in particular low density polyethylene (LDPE) wax, a paraffin, in particular Fischer-Tropsch paraffin, oxidized polyethylenes, complex esters and a mixture of two or more thereof. It may be provided that the lubricant comprises a mixture of 12-hydroxystearic acid, hydrogenated castor oil, low density polyethylene (LDPE) wax, Fischer-Tropsch paraffin and oxidized polyethylenes. It may be provided that the lubricant consists of a mixture of 12-hydroxystearic acid, hydrogenated castor oil, low density polyethylene (LDPE) wax, Fischer-Tropsch paraffin and oxidized polyethylenes.

It may be provided that the 12-hydroxystearic acid is comprised in the composition in an amount selected from the group consisting of 0.01 to 2.5% by weight, 0.05 to 1.5% by weight, 0.1 to 1.0% by weight, 0.2 to 0.7% by weight, 0.3 to 0.5% by weight and 0.2 to 0.4% by weight, for example about 0.3% by weight, based on the total weight of the composition.

It may be provided that the hydrogenated castor oil is comprised in the composition in an amount selected from the group consisting of 0.01 to 2.0% by weight, 0.05 to 1.0% by weight, 0.08 to 0.6% by weight, 0.1 to 0.4% by weight, 0.12 to 0.3% by weight and 0.14 to 0.2% by weight, for example about 0.16% by weight, based on the total weight of the composition.

It may be provided that the low density polyethylene (LDPE) wax is comprised in the composition in an amount selected from the group consisting of 0.01 to 2.0% by weight, 0.05 to 1.0% by weight, 0.08 to 0.6% by weight, 0.1 to 0.4% by weight, 0.15 to 0.3% by weight and 0.18 to 0.25% by weight, for example about 0.2% by weight, based on the total weight of the composition.

It may be provided that the Fischer-Tropsch paraffin is comprised in the composition in an amount selected from the group consisting of 0.01 to 2.0% by weight, 0.02 to 1.0% by weight, 0.03 to 0.6% by weight, 0.04 to 0.3% by weight, 0.05 to 0.2% by weight and 0.06 to 0.1% by weight, for example about 0.07% by weight, based on the total weight of the composition.

It may be provided that the oxidized polyethylenes is comprised in the composition in an amount selected from the group consisting of 0.01 to 2.0% by weight, 0.01 to 1.0% by weight, 0.02 to 0.6% by weight, 0.03 to 0.3% by weight, 0.04 to 0.2% by weight and 0.05 to 0.1% by weight, for example about 0.06% by weight, based on the total weight of the composition.

It may be provided that the composition further comprises a flow agent.

It may be provided that the flow agent is comprised in the composition in an amount selected from the group consisting of at least 1% by weight, at least 2% by weight, at least 3% by weight and at least 4% by weight, based on the total weight of the composition.

It may be provided that the flow agent is comprised in the composition in an amount selected from the group consisting of at most 10% by weight, at most 9% by weight, at most 8% by weight, at most 7% by weight, at most 6% by weight and at most 5% by weight, based on the total weight of the composition.

It may be provided that the flow agent is comprised in the composition in an amount selected from the group consisting of 1 to 10% by weight, 2 to 9% by weight, 3 to 8% by weight and 4 to 6% by weight, based on the total weight of the composition.

It may be provided that the flow agent comprises or consists of acrylic-based or (meth)acrylic-based particles, in particular comprises acrylic-based or (meth)acrylic-based particles having a median particle size in a range from 50 to 300 μm. A corresponding commercially available product is, for example, Paraloid K125.

It may be provided that the composition further comprises an impact strength modifier.

It may be provided that the impact strength modifier is comprised in the composition in an amount selected from the group consisting of at least 1% by weight, at least 2% by weight, at least 3% by weight and at least 4% by weight, based on the total weight of the composition.

It may be provided that the impact strength modifier is comprised in the composition in an amount selected from the group consisting of at most 10% by weight, at most 9% by weight, at most 8% by weight, at most 7% by weight, at most 6% by weight and at most 5% by weight, based on the total weight of the composition.

It may be provided that the impact strength modifier is comprised in the composition in an amount selected from the group consisting of 1 to 10% by weight, 2 to 9% by weight, 3 to 8% by weight and 4 to 6% by weight, based on the total weight of the composition.

It may be provided that the impact strength modifier is an acrylic polymer, for example an acrylic polymer having a D50 particle size of 200 μm and/or a bulk density of 0.4 to 0.5 g/cm³. A corresponding commercially available product is, for example, Kaneka FM 56 K3.

It may be provided that the composition further comprises CaCO₃, in particular as an agent for improving the mechanical properties of a product obtained by means of the composition. Suitable commercially available products are, for example, Precarb 400 or Microcarb 95T.

It may be provided that the CaCO₃ is comprised in the composition in an amount selected from the group consisting of at least 1% by weight, at least 3% by weight, at least 4% by weight and at least 5% by weight and at least 6% by weight, based on the total weight of the composition. It may be provided that the CaCO₃ is comprised in the composition in an amount selected from the group consisting of at most 15% by weight, at most 12.5% by weight, at most 10% by weight, at most 8% by weight and at most 7% by weight, based on the total weight of the composition.

It may be provided that the CaCO₃ is comprised in the composition in an amount selected from the group consisting of 1 to 15% by weight, 3 to 10% by weight, 4 to 8% by weight and 6 to 7% by weight, based on the total weight of the composition.

It may be provided that the composition further comprises an adhesion promoter.

It may be provided that the adhesion promoter is comprised in the composition in an amount selected from the group consisting of at least 0.01% by weight, at least 0.04% by weight, at least 0.08% by weight and at least 0.16% by weight, based on the total weight of the composition.

It may be provided that the adhesion promoter is comprised in the composition in an amount selected from the group consisting of at most 5% by weight, at most 1.6% by weight, at most 0.8% by weight and at most 0.4% by weight, based on the total weight of the composition.

It may be provided that the adhesion promoter is comprised in the composition in an amount selected from the group consisting of 0.01 to 5% by weight, 0.04 to 1.6% by weight, 0.08 to 0.8% by weight, 0.16 to 0.4% by weight, based on the total weight of the composition.

Adhesion promoters according to the present disclosure are substances which produce a tight physical or usually chemical bond in the interface of immiscible substances. It may be provided that the adhesion promoter is a modified polyolefin, in particular a polyolefin modified with chlorine and/or maleic anhydride. It may be provided that the adhesion promoter is maleic acid-grafted polyethylenes or consists thereof. A corresponding commercially available adhesion promoter is, for example, Licocene PE MA 4421.

It may be provided that the composition further comprises a colorant.

It may be provided that the colorant is comprised in the composition in an amount selected from the group consisting of at least 1% by weight, at least 2% by weight and at least 3% by weight, based on the total weight of the composition.

It may be provided that the colorant is comprised in the composition in an amount selected from the group consisting of at most 8% by weight, at most 7% by weight, at most 6% by weight and at most 5% by weight, based on the total weight of the composition.

It may be provided that the colorant is comprised in the composition in an amount selected from the group consisting of 1 to 8% by weight, 2 to 6% by weight and 3 to 5% by weight, for example about 4% by weight, based on the total weight of the composition.

It may be provided that the colorant is selected from the group consisting of TiO2 pigment, blue pigment, violet pigment and a mixture of two or more thereof, in particular comprises a mixture of TiO2 pigment, blue pigment and violet pigment. Corresponding commercially available products are, for example, TiO₂ RFK-3, pigment blue and pigment violet.

It may be provided that the composition further comprises Mg(OH)₂, in particular as an agent for improving the thermostability determined by dehydrochlorination. A corresponding commercially available product is, for example, Luvomaag H002.

It may be provided that the Mg(OH)₂ is comprised in the composition in an amount selected from the group consisting of at least 0.01% by weight, at least 0.04% by weight, at least 0.08% by weight and at least 0.16% by weight, based on the total weight of the composition.

It may be provided that the Mg(OH)₂ is comprised in the composition in an amount selected from the group consisting of at most 5% by weight, at most 1.6% by weight, at most 0.8% by weight and at most 0.4% by weight, based on the total weight of the composition.

It may be provided that the Mg(OH)₂ is comprised in the composition in an amount selected from the group consisting of 0.01 to 5% by weight, 0.04 to 1.6% by weight, 0.08 to 0.8% by weight, 0.16 to 0.4% by weight, based on the total weight of the composition.

According to a fourth aspect of the disclosure, a composition for producing extrusion profiles, in particular extruded window frame profiles or tubular profiles, is provided, comprising:
a polysaccharide, a lignin derivative or a mixture of two or more thereof;
a polymer; and
a nucleophilic co-stabilizer;
   each based on the total weight of the composition.

It may be provided that the polysaccharide, the lignose derivative or the mixture of two or more thereof is comprised in the composition in an amount selected from the group consisting of at least 0.5% by weight, at least 1% by weight, at least 1.5% by weight, at least 2.0% by weight, at least 2.5% by weight, at least 3.0% by weight, at least 4.0% by weight, at least 5.0% by weight, at least 6.0% by weight, at least 7.0% by weight or at least 8.0% by weight, based on the total weight of the composition.

It may be provided that the polysaccharide, the lignose derivative or the mixture of two or more thereof is comprised in the composition in an amount selected from the group consisting of at most 40% by weight, at most 30% by weight, at most 20% by weight, at most 15% by weight, at most 10% by weight or at most 9% by weight, at most 6% by weight, at most 4% by weight and at most 3.5% by weight, based on the total weight of the composition.

It may be provided that the polysaccharide, the lignose derivative or the mixture of two or more thereof is comprised in the composition in an amount selected from the group consisting of 0.5 to 40% by weight, 1 to 30% by weight, 1.5 to 20% by weight, 2 to 15% by weight and 2.5 to 10% by weight, for example about 3% by weight, based on the total weight of the composition.

Polysaccharides in the sense of the present disclosure are carbohydrates in which a large number (at least eleven) monosaccharides (simple sugars) are linked via a glycosidic bond. It may be provided that the polysaccharide is selected from the group consisting of glycogen, starch (amylose and amylopectin), pectins, chitin, callose and cellulose. It may be provided that the polysaccharide comprises cellulose. It may be provided that the polysaccharide is cellulose. In particular if the polysaccharide comprises cellulose or is cellulose, it may be provided that the cellulose is comprised in the composition in an amount of at least 2.4% by weight, preferably at least 4% by weight, particularly preferably at least 5.6% by weight or 8% by weight, parts by weight based on the total weight of the composition. A corresponding exemplary cellulose is, for example, the commercially available product Cellulose Arbocell FD 600-30.

Lignins form a group of phenolic macromolecules which are composed of various monomer building blocks. They are solid biopolymers which are incorporated into the plant cell wall. A substance is referred to as a derivative of a parent compound in the sense of the present disclosure if it has a structural unit which is similar to the functional group of the parent compound and contains a structural element of this functional group in the same oxidation state. It may be provided that the lignin derivative comprises a lignosulfonate. It may be provided that the lignin derivative is lignosulfonate. A corresponding exemplary lignin derivative is, for example, the commercially available product Starlig®Ca from LignoStar.

It may be provided that the polymer is comprised in the composition in an amount selected from the group consisting of at least 20% by weight, at least 30% by weight, at least 40% by weight, at least 50% by weight, at least 55% by weight, at least 60% by weight, at least 70% by weight, at least 75% by weight and at least 78% by weight, based on the total weight of the composition. It may be provided that the polymer is comprised in the composition in an amount selected from the group consisting of at most 99% by weight, at most 95% by weight, at most 92% by weight, at most 90% by weight, at most 87.5% by weight, at most 85% by weight and at most 82% by weight, based on the total weight of the composition.

It may be provided that the polymer is comprised in the composition in an amount selected from the group consisting of 20 to 99% by weight, 30 to 95% by weight, 40 to 92% by weight, 50 to 90% by weight, 60 to 87.5% by weight, 75 to 85% by weight and 78 to 82% by weight, for example about 80% by weight, based on the total weight of the composition.

It may be provided that the polymer is a thermoplastic polymer. The polymer may be selected from
homo- or copolymers which contain, in copolymerized form, at least one monomer which is selected from C₂-C₁₀ monoolefins, such as, for example, ethylene or propylene, 1,3-butadiene, 2-chloro-1,3-butadiene, vinyl alcohol and the C₂-C₁₀ alkyl esters thereof, vinyl chloride, vinylidene chloride, vinylidene fluoride, tetrafluoroethylene, glycidyl acrylate, glycidyl methacrylate, acrylates and methacrylates with alcohol components of branched and unbranched C₁-C10 alcohols, vinylaromatics, such as, for example, styrene, (meth)acrylonitrile, α,β-ethylenically unsaturated mono- and dicarboxylic acids, and maleic anhydride;
homo- and copolymers of vinyl acetals;
polyvinyl esters;
polycarbonates (PC);
polyesters, such as polyalkylene terephthalates, polyhydroxyalkanoates (PHA), polybutylene succinates (PBS), polybutylene succinate adipates (PBSA);
polyethers;
polyether ketones;
thermoplastic polyurethanes (TPU);
polysulfides;
polysulfones;
natural rubber
   and mixtures thereof.

The inventors have recognized that, in particular, fractions of more than 15% by weight, based on the total weight of the plastic composition, of elastomers, in particular of homo- and copolymers of vinyl acetate and/or ethylene, in particular of ethylene-vinyl acetate copolymers, have a negative effect on the mechanical properties of the plastic composition, in particular such a negative effect that the materials can no longer be used for producing extrusion profiles, but at best as material for foaming extrusion profiles, such as door and window frame profiles. Furthermore, elastomers, such as ethylene-vinyl acetate copolymers, are expensive. Accordingly, it may be provided that the plastic composition has a fraction of at most 15% by weight, preferably of at most 10% by weight, 5% by weight, 3% by weight, 1% by weight, 0.5% by weight, 0.1% by weight, is particularly preferably free of elastomers, in particular of homo- and copolymers of vinyl acetate and/or ethylene, for example of ethylene-vinyl acetate copolymers. Alternatively, or additionally, the plastic composition comprises a fraction of at most 0.5% by weight, 0.3% by weight, 0.1% by weight, 0.05% by weight, 0.01% by weight, is preferably free of foam stabilizers.

It may be provided that the polymer comprises a halogen-containing polymer, in particular consists of at least 10% by weight, 20% by weight, 30% by weight, 40% by weight, 50% by weight, 60% by weight, 70% by weight, 80% by weight, 90% by weight, 95% by weight, 98% by weight, 99% by weight, 99.5% by weight, 99.9% by weight or 100% by weight thereof. In this context, a halogen-containing polymer is in particular a hydrocarbon-based polymer in which at least one hydrogen atom per monomer unit has been replaced by one of the halogens fluorine, chlorine, bromine or iodine. In the case of a copolymer, at least one hydrogen atom per comonomer unit of at least one of the comonomers has been replaced by one of the halogens fluorine, chlorine, bromine or iodine. It may be provided that the halogen-containing polymer comprises a chlorine-containing polymer, a fluorine-containing polymer or a chlorine- and fluorine-containing polymer, in particular consists of at least 10% by weight, 20% by weight, 30% by weight, 40% by weight, 50% by weight, 60% by weight, 70% by weight, 80% by weight, 90% by weight, 95% by weight, 98% by weight, 99% by weight, 99.5% by weight, 99.9% by weight or 100% by weight thereof. It may be provided that the halogen-containing polymer is selected, in particular at least 10% by weight, 20% by weight, 30% by weight, 40% by weight, 50% by weight, 60% by weight, 70% by weight, 80% by weight, 90% by weight, 95% by weight, 98% by weight, 99% by weight, 99.5% by weight, 99.9% by weight or 100% by weight thereof, from polyvinyl chloride, chlorinated polyethylene, polytetrafluoroethylene, polytrichlorofluoroethylene, polyvinylidene fluoride or mixtures of two or more thereof. It may be provided that the halogen-containing polymer comprises polyvinyl chloride, in particular at least 10% by weight, 20% by weight, 30% by weight, 40% by weight, 50% by weight, 60% by weight, 70% by weight, 80% by weight, 90% by weight, 95% by weight, 98% by weight, 99% by weight, 99.5% by weight, 99.9% by weight thereof. It may be provided that the halogen-containing polymer is polyvinyl chloride.

It may be provided that the halogen-containing polymer consists of at least one first polyvinyl chloride and of at least one second polyvinyl chloride. It may be provided that the halogen-containing polymer consists of a first polyvinyl chloride and of a second polyvinyl chloride. It may be provided that the first polyvinyl chloride and the second polyvinyl chloride are present in the halogen-containing polymer in a weight ratio selected from the group consisting of from 10:1 to 1:10, from 5:1 to 1:5 and from 2:1 to 1:2, in particular in a weight ratio of approximately 6:4.

It may be provided that the first polyvinyl chloride has a K value according to DIN EN ISO 1628-2 (in the version valid on the filing date) selected from the group consisting of from 60 to 70, from 65 to 69, from 65 to 68 and 67.5 to 68.5, in particular approximately 68. It may be provided that the first polyvinyl chloride has a bulk density according to DIN EN ISO 60 (in the version valid on the filing date) selected from the group consisting of from 0.4 to 0.8 g/cm³ and from 0.5 to 0.6 g/cm³, in particular approximately 0.57. It may be provided that the first polyvinyl chloride has a value of sieve analysis—residue on 0.063 mm sieve according to DIN EN ISO 4610 (in the version valid on the filing date) selected from the group consisting of at least 90% and at least 95%, in particular at least approximately 96%. It may be provided that the first polyvinyl chloride has a value of sieve analysis—residue on 0.250 mm sieve according to DIN EN ISO 4610 (in the version valid on the filing date) selected from the group consisting of at least 1% and at least 2%, in particular at least approximately 3%. It may be provided that the first polyvinyl chloride has a proportion of volatile constituents according to DIN EN ISO 1269 selected from the group consisting of at most 1% and at most 0.5%, in particular at most approximately 0.3%. It may be provided that the first polyvinyl chloride has a plasticizer absorption according to ISO 4608 (in the version valid on the filing date) selected from the group consisting of from 10 to 30%, from 15 to 25% and from 18 to 22%, in particular approximately 20%. A corresponding commercially available first polyvinyl chloride is, for example, Vynova S6830.

It may be provided that the second polyvinyl chloride has a K value according to DIN EN ISO 1628-2 (in the version valid on the filing date) selected from the group consisting of from 60 to 70, from 63 to 68, from 65 to 68, from 65 to 67 and from 65.5 to 66.5, in particular approximately 66. It may be provided that the second polyvinyl chloride has a bulk density according to DIN EN ISO 60 (in the version valid on the filing date) selected from the group consisting of from 0.4 to 0.8 g/cm³ and from 0.5 to 0.6 g/cm³, in particular approximately 0.56. It may be provided that the second polyvinyl chloride has a value of sieve analysis—residue on 0.063 mm sieve according to DIN EN ISO 4610 (in the version valid on the filing date) selected from the group consisting of at least 90% and at least 95%, in particular at least approximately 97%. It may be provided that the second polyvinyl chloride has a value of sieve analysis—residue on 0.200 mm sieve according to DIN EN ISO 4610 (in the version valid on the filing date) selected from the group consisting of at most 20% and at most 17%, in particular at most approximately 15%. It may be provided that the second polyvinyl chloride has a proportion of volatile constituents according to DIN EN ISO 1269 selected from the group consisting of at most 1% and at most 0.5%, in particular at most approximately 0.3%. A corresponding commercially available second polyvinyl chloride is, for example, Primex S 6658 from vestolit. It may be provided that the co-stabilizer is comprised in the composition in an amount selected from the group consisting of at least 0.01% by weight, at least 0.05% by weight, at least 0.1% by weight, at least 0.2% by weight, at least 0.3% by weight and at least 0.4% by weight, based on the total weight of the composition.

It may be provided that the co-stabilizer is comprised in the composition in an amount selected from the group consisting of at most 5% by weight, at most 4% by weight, at most 3% by weight, at most 2% by weight, at most 1% by weight and at most 0.5% by weight, based on the total weight of the composition.

It may be provided that the co-stabilizer is comprised in the composition in an amount selected from the group consisting of 0.01 to 5% by weight, 0.05 to 4% by weight, 0.1 to 3% by weight, 0.2 to 2% by weight, 0.3 to 1% by weight and 0.3 to 0.5% by weight, for example about 0.4% by weight, based on the total weight of the composition.

The nucleophilic co-stabilizer comprises, or consists of, at least one nucleophilic compound. It may be provided that the co-stabilizer comprises, or is, in addition to a nucleophilic compound, an antioxidant, an acid scavenger or a mixture of two or more thereof. It may be provided that the co-stabilizer comprises, or is, a mixture of at least one nucleophilic compound, at least one antioxidant and at least one acid scavenger.

It may be provided that the nucleophilic compound comprises an organic compound having two or more, preferably three, hydroxyl groups, for example tris(2-hydroxyethyl)isocyanurate, β-diketone. It may be provided that the nucleophilic compound comprises, or consists of, tris(2-hydroxyethyl)isocyanurate, β-diketone, calcium acetylacetonate or a mixture of two or more thereof. It may be provided that the nucleophilic compound comprises, or consists of, a mixture of tris(2-hydroxyethyl)isocyanurate, β-diketone and calcium acetylacetonate.

In particular halogen, for example a labile chlorine atom described above, of halogen-containing polymers, for example PVC, can be substituted by means of the nucleophilic compound.

Preferably, the halogen-containing polymer is a polymer derived from the halogen-containing polymer, preferably a polymer derived by dehydrohalogenation, preferably dehydrochlorination. Preferably, the halogen-containing polymer comprises at least one carbon-carbon double bond.

As already described above, the thermostability of the polymer can be increased by such a substitution. In this context, the halogen is preferably iodine, bromine, chlorine or fluorine, particularly preferably chlorine or fluorine, in particular chlorine.

It may be provided that the calcium acetylacetonate is comprised in the composition in an amount selected from the group consisting of 0.01 to 2.0% by weight, 0.02 to 1.0% by weight, 0.03 to 0.6% by weight, 0.04 to 0.3% by weight, 0.05 to 0.2% by weight and 0.06 to 0.1% by weight, for example about 0.07% by weight, based on the total weight of the composition.

It may be provided that the tris(2-hydroxyethyl)isocyanurate is comprised in the composition in an amount selected from the group consisting of 0.01 to 5.0% by weight, 0.03 to 2.0% by weight, 0.05 to 1.0% by weight, 0.08 to 0.7% by weight, 0.1 to 0.5% by weight and 0.12 to 0.2% by weight, for example about 0.14% by weight, based on the total weight of the composition.

It may be provided that the sodium aluminosilicate is comprised in the composition in an amount selected from the group consisting of 0.01 to 2.0% by weight, 0.01 to 1.0% by weight, 0.02 to 0.6% by weight, 0.03 to 0.3% by weight, 0.04 to 0.2% by weight and 0.05 to 0.1% by weight, for example about 0.06% by weight, based on the total weight of the composition.

It may be provided that the β-diketone is comprised in the composition in an amount selected from the group consisting of 0.01 to 2.0% by weight, 0.02 to 1.0% by weight, 0.03 to 0.6% by weight, 0.05 to 0.3% by weight, 0.06 to 0.2% by weight and 0.07 to 0.1% by weight, for example about 0.08% by weight, based on the total weight of the composition.

It may be provided that the antioxidant is a sterically hindered phenolic compound, for example octadecyl-[3-(3,5-di-tert-butyl-4-hydroxyphenyl)propionate], which is commercially available as Irganox 1076.

It may be provided that the antioxidant, in particular the sterically hindered phenolic compound, preferably octadecyl-[3-(3,5-di-tert-butyl-4-hydroxyphenyl)propionate], is comprised in the composition in an amount selected from the group consisting of 0.01 to 2.0% by weight, 0.02 to 1.0% by weight, 0.03 to 0.6% by weight, 0.04 to 0.3% by weight, 0.05 to 0.2% by weight and 0.06 to 0.1% by weight, for example about 0.07% by weight, based on the total weight of the composition.

It may be provided that the acid scavenger comprises, or consists of, hydrotalcite, zeolite or a mixture of two or more thereof, preferably comprises, or consists of, a mixture of hydrotalcite and zeolite.

It may be provided that the composition further comprises a heat stabilizer.

Plastics are sensitive to the action of heat. Above a temperature characteristic for the material (decomposition temperature), the decomposition of the molecular structure sets in. Heat stabilizers serve to prevent this.

It may be provided that the heat stabilizer is comprised in the composition in an amount selected from the group consisting of at least 0.01% by weight, at least 0.05% by weight, at least 0.1% by weight, at least 0.2% by weight, at least 0.3% by weight, at least 0.4% by weight, at least 0.5% by weight, at least 0.6% by weight and at least 0.7% by weight, based on the total weight of the composition.

It may be provided that the heat stabilizer is comprised in the composition in an amount selected from the group consisting of at most 10% by weight, at most 7.5% by weight, at most 5% by weight, at most 2.5% by weight, at most 2% by weight, at most 1.5% by weight, at most 1.25% by weight, at most 1% by weight and at most 0.9% by weight, based on the total weight of the composition.

It may be provided that the heat stabilizer is comprised in the composition in an amount selected from the group consisting of 0.01 to 10% by weight, 0.1 to 7.5% by weight, 0.2 to 5% by weight, 0.3 to 2.5% by weight, 0.4 to 2% by weight, 0.5 to 1.5% by weight, 0.6 to 1.25% by weight and 0.7 to 0.9% by weight, for example about 0.8% by weight, based on the total weight of the composition.

It may be provided that the heat stabilizer comprises an organic barium, zinc, tin and cadmium compound and/or an inorganic lead salt. It may be provided that the heat stabilizer comprises an organic barium compound and/or an organic cadmium compound. It may be provided that the heat stabilizer comprises an organic barium compound and an organic cadmium compound.

It may be provided that the heat stabilizer comprises zinc stearate, calcium stearate or a mixture thereof. It may be provided that the heat stabilizer comprises a mixture of zinc stearate and calcium stearate in a weight ratio of 1:1 to 5:1 in an amount of at least 90% by weight, based on the total weight of the heat stabilizer. It may be provided that the heat stabilizer consists of a mixture of zinc stearate and calcium stearate in a weight ratio of 1:1 to 5:1. It may be provided that the heat stabilizer consists of a mixture of zinc stearate and calcium stearate in a weight ratio of 2:1 to 3:1. A corresponding exemplary zinc stearate is, for example, the commercially available product Ligastar Zn 101/6. A corresponding exemplary calcium stearate is, for example, the commercially available product Ligastar CA 600.

It may be provided that the zinc stearate is comprised in the composition in an amount selected from the group consisting of 0.05 to 5.0% by weight, 0.1 to 2.0% by weight, 0.2 to 1.0% by weight, 0.3 to 1.0% by weight, 0.4 to 0.8% by weight and 0.5 to 0.6% by weight, for example about 0.55% by weight, based on the total weight of the composition and/or that the calcium stearate is comprised in the composition in an amount selected from the group consisting of 0.01 to 2.5% by weight, 0.05 to 1.0% by weight, 0.1 to 1.0% by weight, 0.15 to 0.5% by weight and 0.2 to 0.3% by weight, for example about 0.24% by weight, based on the total weight of the composition.

It may be provided that the composition further comprises a lubricant.

It may be provided that the lubricant is comprised in the composition in an amount selected from the group consisting of at least 0.01% by weight, at least 0.05% by weight, at least 0.1% by weight, at least 0.3% by weight, at least 0.5% by weight and at least 0.7% by weight, based on the total weight of the composition.

It may be provided that the lubricant is comprised in the composition in an amount selected from the group consisting of at most 5% by weight, at most 4% by weight, at most 3% by weight, at most 2% by weight, at most 1% by weight and at most 0.8% by weight, based on the total weight of the composition.

It may be provided that the lubricant is comprised in the composition in an amount selected from the group consisting of 0.01 to 5% by weight, 0.05 to 4% by weight, 0.1 to 3% by weight, 0.2 to 2% by weight, 0.4 to 1% by weight and 0.6 to 0.9% by weight, for example about 0.75% by weight, based on the total weight of the composition.

It may be provided that the lubricant comprises (or consists of) at least one selected from the group consisting of a fatty acid, in particular 12-hydroxystearic acid, an oil, in particular hydrogenated castor oil, a wax, in particular low density polyethylene (LDPE) wax, a paraffin, in particular Fischer-Tropsch paraffin, oxidized polyethylenes, complex esters and a mixture of two or more thereof. It may be provided that the lubricant comprises a mixture of 12-hydroxystearic acid, hydrogenated castor oil, low density polyethylene (LDPE) wax, Fischer-Tropsch paraffin and oxidized polyethylenes. It may be provided that the lubricant consists of a mixture of 12-hydroxystearic acid, hydrogenated castor oil, low density polyethylene (LDPE) wax, Fischer-Tropsch paraffin and oxidized polyethylenes.

It may be provided that the 12-hydroxystearic acid is comprised in the composition in an amount selected from the group consisting of 0.01 to 2.5% by weight, 0.05 to 1.5% by weight, 0.1 to 1.0% by weight, 0.2 to 0.7% by weight, 0.3 to 0.5% by weight and 0.2 to 0.4% by weight, for example about 0.3% by weight, based on the total weight of the composition.

It may be provided that the hydrogenated castor oil is comprised in the composition in an amount selected from the group consisting of 0.01 to 2.0% by weight, 0.05 to 1.0% by weight, 0.08 to 0.6% by weight, 0.1 to 0.4% by weight, 0.12 to 0.3% by weight and 0.14 to 0.2% by weight, for example about 0.16% by weight, based on the total weight of the composition.

It may be provided that the low density polyethylene (LDPE) wax is comprised in the composition in an amount selected from the group consisting of 0.01 to 2.0% by weight, 0.05 to 1.0% by weight, 0.08 to 0.6% by weight, 0.1 to 0.4% by weight, 0.15 to 0.3% by weight and 0.18 to 0.25% by weight, for example about 0.2% by weight, based on the total weight of the composition.

It may be provided that the Fischer-Tropsch paraffin is comprised in the composition in an amount selected from the group consisting of 0.01 to 2.0% by weight, 0.02 to 1.0% by weight, 0.03 to 0.6% by weight, 0.04 to 0.3% by weight, 0.05 to 0.2% by weight and 0.06 to 0.1% by weight, for example about 0.07% by weight, based on the total weight of the composition.

It may be provided that the oxidized polyethylenes is comprised in the composition in an amount selected from the group consisting of 0.01 to 2.0% by weight, 0.01 to 1.0% by weight, 0.02 to 0.6% by weight, 0.03 to 0.3% by weight, 0.04 to 0.2% by weight and 0.05 to 0.1% by weight, for example about 0.06% by weight, based on the total weight of the composition.

It may be provided that the composition further comprises a flow agent.

It may be provided that the flow agent is comprised in the composition in an amount selected from the group consisting of at least 1% by weight, at least 2% by weight, at least 3% by weight and at least 4% by weight, based on the total weight of the composition.

It may be provided that the flow agent is comprised in the composition in an amount selected from the group consisting of at most 10% by weight, at most 9% by weight, at most 8% by weight, at most 7% by weight, at most 6% by weight and at most 5% by weight, based on the total weight of the composition.

It may be provided that the flow agent is comprised in the composition in an amount selected from the group consisting of 1 to 10% by weight, 2 to 9% by weight, 3 to 8% by weight and 4 to 6% by weight, based on the total weight of the composition.

It may be provided that the flow agent comprises or consists of acrylic-based or (meth)acrylic-based particles, in particular comprises acrylic-based or (meth)acrylic-based particles having a median particle size in a range from 50 to 300 μm. A corresponding commercially available product is, for example, Paraloid K125.

It may be provided that the composition further comprises an impact strength modifier.

It may be provided that the impact strength modifier is comprised in the composition in an amount selected from the group consisting of at least 1% by weight, at least 2% by weight, at least 3% by weight and at least 4% by weight, based on the total weight of the composition.

It may be provided that the impact strength modifier is comprised in the composition in an amount selected from the group consisting of at most 10% by weight, at most 9% by weight, at most 8% by weight, at most 7% by weight, at most 6% by weight and at most 5% by weight, based on the total weight of the composition.

It may be provided that the impact strength modifier is comprised in the composition in an amount selected from the group consisting of 1 to 10% by weight, 2 to 9% by weight, 3 to 8% by weight and 4 to 6% by weight, based on the total weight of the composition.

It may be provided that the impact strength modifier is an acrylic polymer, for example an acrylic polymer having a D50 particle size of 200 μm and/or a bulk density of 0.4 to 0.5 g/cm³. A corresponding commercially available product is, for example, Kaneka FM 56 K3.

It may be provided that the composition further comprises CaCO₃, in particular as an agent for improving the mechanical properties of a product obtained by means of the composition. Suitable commercially available products are, for example, Precarb 400 or Microcarb 95T.

It may be provided that the CaCO₃ is comprised in the composition in an amount selected from the group consisting of at least 1% by weight, at least 3% by weight, at least 4% by weight and at least 5% by weight and at least 6% by weight, based on the total weight of the composition. It may be provided that the CaCO₃ is comprised in the composition in an amount selected from the group consisting of at most 15% by weight, at most 12.5% by weight, at most 10% by weight, at most 8% by weight and at most 7% by weight, based on the total weight of the composition.

It may be provided that the CaCO₃ is comprised in the composition in an amount selected from the group consisting of 1 to 15% by weight, 3 to 10% by weight, 4 to 8% by weight and 6 to 7% by weight, based on the total weight of the composition.

It may be provided that the composition further comprises an adhesion promoter.

It may be provided that the adhesion promoter is comprised in the composition in an amount selected from the group consisting of at least 0.01% by weight, at least 0.04% by weight, at least 0.08% by weight and at least 0.16% by weight, based on the total weight of the composition.

It may be provided that the adhesion promoter is comprised in the composition in an amount selected from the group consisting of at most 5% by weight, at most 1.6% by weight, at most 0.8% by weight and at most 0.4% by weight, based on the total weight of the composition.

It may be provided that the adhesion promoter is comprised in the composition in an amount selected from the group consisting of 0.01 to 5% by weight, 0.04 to 1.6% by weight, 0.08 to 0.8% by weight, 0.16 to 0.4% by weight, based on the total weight of the composition.

Adhesion promoters according to the present disclosure are substances which produce a tight physical or usually chemical bond in the interface of immiscible substances. It may be provided that the adhesion promoter is a modified polyolefin, in particular a polyolefin modified with chlorine and/or maleic anhydride. It may be provided that the adhesion promoter is maleic acid-grafted polyethylenes or consists thereof. A corresponding commercially available adhesion promoter is, for example, Licocene PE MA 4421.

It may be provided that the composition further comprises a colorant.

It may be provided that the colorant is comprised in the composition in an amount selected from the group consisting of at least 1% by weight, at least 2% by weight and at least 3% by weight, based on the total weight of the composition.

It may be provided that the colorant is comprised in the composition in an amount selected from the group consisting of at most 8% by weight, at most 7% by weight, at most 6% by weight and at most 5% by weight, based on the total weight of the composition.

It may be provided that the colorant is comprised in the composition in an amount selected from the group consisting of 1 to 8% by weight, 2 to 6% by weight and 3 to 5% by weight, for example about 4% by weight, based on the total weight of the composition.

It may be provided that the colorant is selected from the group consisting of TiO2 pigment, blue pigment, violet pigment and a mixture of two or more thereof, in particular comprises a mixture of TiO2 pigment, blue pigment and violet pigment. Corresponding commercially available products are, for example, TiO₂ RFK-3, pigment blue and pigment violet.

It may be provided that the composition further comprises Mg(OH)₂, in particular as an agent for improving the thermostability determined by dehydrochlorination. A corresponding commercially available product is, for example, Luvomaag H002.

It may be provided that the Mg(OH)₂ is comprised in the composition in an amount selected from the group consisting of at least 0.01% by weight, at least 0.04% by weight, at least 0.08% by weight and at least 0.16% by weight, based on the total weight of the composition.

It may be provided that the Mg(OH)₂ is comprised in the composition in an amount selected from the group consisting of at most 5% by weight, at most 1.6% by weight, at most 0.8% by weight and at most 0.4% by weight, based on the total weight of the composition.

It may be provided that the Mg(OH)₂ is comprised in the composition in an amount selected from the group consisting of 0.01 to 5% by weight, 0.04 to 1.6% by weight, 0.08 to 0.8% by weight, 0.16 to 0.4% by weight, based on the total weight of the composition.

According to a fifth aspect, the disclosure relates to an extrusion profile comprising the composition according to one of aspects 1 to 4.

According to the present disclosure, an extrusion profile is a profile which is produced or can be produced in the extrusion method. A profile within the meaning of the present disclosure is a structural profile, for instance an elongate semi-finished product. During the extrusion, i.e. in the extrusion method, plastically deformable to highly viscous masses are continuously pressed out of a shaping opening (also referred to as calibration, die, die or mouthpiece) under pressure. The shaped mass is referred to as an extrudate and generally cures on emerging from the opening of the tool as a result of cooling or chemical reaction. By means of extrusion, profiles with complex cross sections of any desired length can be produced.

It can be provided that the extrusion profile is an extruded frame profile, in particular window frame profile or door frame profile, or an extruded tubular profile.

It can be provided that the extrusion profile consists of the composition according to one of aspects 1 to 4. In particular, the extrusion profile can be free of discrete reinforcements, such as reinforcements and inserts, for example steel inserts, continuous fibers and/or organosheets.

According to a sixth aspect, the disclosure relates to an extrusion profile comprising a composition, in particular according to one of aspects 1 to 4, comprising
a polysaccharide, a lignin derivative or a mixture of two or more thereof; and
a polymer;
wherein the proportion by weight of the polysaccharide, of the lignin derivative and/or of the mixture, based on the total weight of the composition, is such that the composition has a flexural modulus of at least 2,300 MPa, preferably of at least 2,350 MPa, 2,400 MPa, 2,450 MPa, 2,500 MPa, 2,600 MPa, 2,700 MPa, 2,800 MPa, 2,900 MPa, 3,000 MPa or 3,050 MPa. It may be provided that the flexural modulus is determined according to DIN EN ISO 178 (in the version valid on the filing date).

It may be provided that the polysaccharide, the lignose derivative or the mixture of two or more thereof is comprised in the composition in an amount selected from the group consisting of at least 0.5% by weight, at least 1% by weight, at least 1.5% by weight, at least 2.0% by weight, at least 2.5% by weight, at least 3.0% by weight, at least 4.0% by weight, at least 5.0% by weight, at least 6.0% by weight, at least 7.0% by weight or at least 8.0% by weight, based on the total weight of the composition.

It may be provided that the polysaccharide, the lignose derivative or the mixture of two or more thereof is comprised in the composition in an amount selected from the group consisting of at most 40% by weight, at most 30% by weight, at most 20% by weight, at most 15% by weight, at most 10% by weight or at most 9% by weight, at most 6% by weight, at most 4% by weight and at most 3.5% by weight, based on the total weight of the composition.

It may be provided that the polysaccharide, the lignose derivative or the mixture of two or more thereof is comprised in the composition in an amount selected from the group consisting of 0.5 to 40% by weight, 1 to 30% by weight, 1.5 to 20% by weight, 2 to 15% by weight and 2.5 to 10% by weight, for example about 3% by weight, based on the total weight of the composition.

Polysaccharides in the sense of the present disclosure are carbohydrates in which a large number (at least eleven) monosaccharides (simple sugars) are linked via a glycosidic bond. It may be provided that the polysaccharide is selected from the group consisting of glycogen, starch (amylose and amylopectin), pectins, chitin, callose and cellulose. It may be provided that the polysaccharide comprises cellulose. It may be provided that the polysaccharide is cellulose. In particular if the polysaccharide comprises cellulose or is cellulose, it may be provided that the cellulose is comprised in the composition in an amount of at least 2.4% by weight, preferably at least 4% by weight, particularly preferably at least 5.6% by weight or 8% by weight, parts by weight based on the total weight of the composition. A corresponding exemplary cellulose is, for example, the commercially available product Cellulose Arbocell FD 600-30.

Lignins form a group of phenolic macromolecules which are composed of various monomer building blocks. They are solid biopolymers which are incorporated into the plant cell wall. A substance is referred to as a derivative of a parent compound in the sense of the present disclosure if it has a structural unit which is similar to the functional group of the parent compound and contains a structural element of this functional group in the same oxidation state. It may be provided that the lignin derivative comprises a lignosulfonate. It may be provided that the lignin derivative is lignosulfonate. A corresponding exemplary lignin derivative is, for example, the commercially available product Starlig®Ca from LignoStar.

It may be provided that the polymer is a thermoplastic polymer. The polymer may be selected from
homo- or copolymers which contain, in copolymerized form, at least one monomer which is selected from C₂-C₁₀ monoolefins, such as, for example, ethylene or propylene, 1,3-butadiene, 2-chloro-1,3-butadiene, vinyl alcohol and the C₂-C₁₀ alkyl esters thereof, vinyl chloride, vinylidene chloride, vinylidene fluoride, tetrafluoroethylene, glycidyl acrylate, glycidyl methacrylate, acrylates and methacrylates with alcohol components of branched and unbranched C₁-C10 alcohols, vinylaromatics, such as, for example, styrene, (meth)acrylonitrile, α,β-ethylenically unsaturated mono- and dicarboxylic acids, and maleic anhydride;
homo- and copolymers of vinyl acetals;
polyvinyl esters;
polycarbonates (PC);
polyesters, such as polyalkylene terephthalates, polyhydroxyalkanoates (PHA), polybutylene succinates (PBS), polybutylene succinate adipates (PBSA);
polyethers;
polyether ketones;
thermoplastic polyurethanes (TPU);
polysulfides;
polysulfones;
natural rubber
   and mixtures thereof.

It may be provided that the polymer is a halogen-containing polymer. In this context, a halogen-containing polymer is in particular a hydrocarbon-based polymer in which at least one hydrogen atom per monomer unit has been replaced by one of the halogens fluorine, chlorine, bromine or iodine. In the case of a copolymer, at least one hydrogen atom per comonomer unit of at least one of the comonomers has been replaced by one of the halogens fluorine, chlorine, bromine or iodine. It may be provided that the halogen-containing polymer comprises, or is, a chlorine-containing polymer, a fluorine-containing polymer or a chlorine- and fluorine-containing polymer. It may be provided that the halogen-containing polymer is selected from polyvinyl chloride, chlorinated polyethylene, polytetrafluoroethylene, polytrichlorofluoroethylene, polyvinylidene fluoride or mixtures of two or more thereof. It may be provided that the halogen-containing polymer comprises polyvinyl chloride. It may be provided that the halogen-containing polymer is polyvinyl chloride.

It may be provided that the halogen-containing polymer consists of at least one first polyvinyl chloride and of at least one second polyvinyl chloride. It may be provided that the halogen-containing polymer consists of a first polyvinyl chloride and of a second polyvinyl chloride. It may be provided that the first polyvinyl chloride and the second polyvinyl chloride are present in the halogen-containing polymer in a weight ratio selected from the group consisting of from 10:1 to 1:10, from 5:1 to 1:5 and from 2:1 to 1:2, in particular in a weight ratio of approximately 6:4.

It may be provided that the first polyvinyl chloride has a K value according to DIN EN ISO 1628-2 (in the version valid on the filing date) selected from the group consisting of from 60 to 70, from 65 to 69, from 65 to 68 and 67.5 to 68.5, in particular approximately 68. It may be provided that the first polyvinyl chloride has a bulk density according to DIN EN ISO 60 (in the version valid on the filing date) selected from the group consisting of from 0.4 to 0.8 g/cm³ and from 0.5 to 0.6 g/cm³, in particular approximately 0.57. It may be provided that the first polyvinyl chloride has a value of sieve analysis—residue on 0.063 mm sieve according to DIN EN ISO 4610 (in the version valid on the filing date) selected from the group consisting of at least 90% and at least 95%, in particular at least approximately 96%. It may be provided that the first polyvinyl chloride has a value of sieve analysis—residue on 0.250 mm sieve according to DIN EN ISO 4610 (in the version valid on the filing date) selected from the group consisting of at least 1% and at least 2%, in particular at least approximately 3%. It may be provided that the first polyvinyl chloride has a proportion of volatile constituents according to DIN EN ISO 1269 selected from the group consisting of at most 1% and at most 0.5%, in particular at most approximately 0.3%. It may be provided that the first polyvinyl chloride has a plasticizer absorption according to ISO 4608 (in the version valid on the filing date) selected from the group consisting of from 10 to 30%, from 15 to 25% and from 18 to 22%, in particular approximately 20%. A corresponding commercially available first polyvinyl chloride is, for example, Vynova S6830.

It may be provided that the second polyvinyl chloride has a K value according to DIN EN ISO 1628-2 (in the version valid on the filing date) selected from the group consisting of from 60 to 70, from 63 to 68, from 65 to 68, from 65 to 67 and from 65.5 to 66.5, in particular approximately 66. It may be provided that the second polyvinyl chloride has a bulk density according to DIN EN ISO 60 (in the version valid on the filing date) selected from the group consisting of from 0.4 to 0.8 g/cm³ and from 0.5 to 0.6 g/cm³, in particular approximately 0.56. It may be provided that the second polyvinyl chloride has a value of sieve analysis—residue on 0.063 mm sieve according to DIN EN ISO 4610 (in the version valid on the filing date) selected from the group consisting of at least 90% and at least 95%, in particular at least approximately 97%. It may be provided that the second polyvinyl chloride has a value of sieve analysis—residue on 0.200 mm sieve according to DIN EN ISO 4610 (in the version valid on the filing date) selected from the group consisting of at most 20% and at most 17%, in particular at most approximately 15%. It may be provided that the second polyvinyl chloride has a proportion of volatile constituents according to DIN EN ISO 1269 selected from the group consisting of at most 1% and at most 0.5%, in particular at most approximately 0.3%. A corresponding commercially available second polyvinyl chloride is, for example, Primex S 6658 from vestolit.

In particular, it may be provided that the polysaccharide, in particular cellulose, is comprised in the composition in an amount of 0.8 to 8% by weight, preferably of 1.6 to 8% by weight, particularly preferably of 2.4 to 8% by weight, based on the total weight of the composition.

It may be provided that the extrusion profile is an extruded window frame profile or an extruded tubular profile.

According to a seventh aspect, the disclosure relates to an extrusion profile comprising a composition, in particular according to one of aspects 1 to 4, comprising:
a polysaccharide, a lignin derivative or a mixture of two or more thereof; and
a polymer; wherein
the proportion by weight of the polysaccharide, of the lignin derivative and/or of the mixture, based on the total weight of the composition, is such that the composition has a corner strength of at least 5,500 Newtons, preferably of at least 6,000 Newtons, 6,500 Newtons, 7,000 Newtons or 7,500 Newtons. It may be provided that the corner strength is determined according to DIN EN 514:2018.

It may be provided that the polysaccharide, the lignose derivative or the mixture of two or more thereof is comprised in the composition in an amount selected from the group consisting of at least 0.5% by weight, at least 1% by weight, at least 1.5% by weight, at least 2.0% by weight, at least 2.5% by weight, at least 3.0% by weight, at least 4.0% by weight, at least 5.0% by weight, at least 6.0% by weight, at least 7.0% by weight or at least 8.0% by weight, based on the total weight of the composition.

It may be provided that the polysaccharide, the lignose derivative or the mixture of two or more thereof is comprised in the composition in an amount selected from the group consisting of at most 40% by weight, at most 30% by weight, at most 20% by weight, at most 15% by weight, at most 10% by weight or at most 9% by weight, at most 6% by weight, at most 4% by weight and at most 3.5% by weight, based on the total weight of the composition.

It may be provided that the polysaccharide, the lignose derivative or the mixture of two or more thereof is comprised in the composition in an amount selected from the group consisting of 0.5 to 40% by weight, 1 to 30% by weight, 1.5 to 20% by weight, 2 to 15% by weight and 2.5 to 10% by weight, for example about 3% by weight, based on the total weight of the composition.

Polysaccharides in the sense of the present disclosure are carbohydrates in which a large number (at least eleven) monosaccharides (simple sugars) are linked via a glycosidic bond. It may be provided that the polysaccharide is selected from the group consisting of glycogen, starch (amylose and amylopectin), pectins, chitin, callose and cellulose. It may be provided that the polysaccharide comprises cellulose. It may be provided that the polysaccharide is cellulose. In particular if the polysaccharide comprises cellulose or is cellulose, it may be provided that the cellulose is comprised in the composition in an amount of at least 2.4% by weight, preferably at least 4% by weight, particularly preferably at least 5.6% by weight or 8% by weight, parts by weight based on the total weight of the composition. A corresponding exemplary cellulose is, for example, the commercially available product Cellulose Arbocell FD 600-30.

Lignins form a group of phenolic macromolecules which are composed of various monomer building blocks. They are solid biopolymers which are incorporated into the plant cell wall. A substance is referred to as a derivative of a parent compound in the sense of the present disclosure if it has a structural unit which is similar to the functional group of the parent compound and contains a structural element of this functional group in the same oxidation state. It may be provided that the lignin derivative comprises a lignosulfonate. It may be provided that the lignin derivative is lignosulfonate. A corresponding exemplary lignin derivative is, for example, the commercially available product Starlig®Ca from LignoStar.

It may be provided that the polymer is a thermoplastic polymer. The polymer may be selected from
homo- or copolymers which contain, in copolymerized form, at least one monomer which is selected from C₂-C₁₀ monoolefins, such as, for example, ethylene or propylene, 1,3-butadiene, 2-chloro-1,3-butadiene, vinyl alcohol and the C₂-C₁₀ alkyl esters thereof, vinyl chloride, vinylidene chloride, vinylidene fluoride, tetrafluoroethylene, glycidyl acrylate, glycidyl methacrylate, acrylates and methacrylates with alcohol components of branched and unbranched C₁-C10 alcohols, vinylaromatics, such as, for example, styrene, (meth)acrylonitrile, α,β-ethylenically unsaturated mono- and dicarboxylic acids, and maleic anhydride;
homo- and copolymers of vinyl acetals;
polyvinyl esters;
polycarbonates (PC);
polyesters, such as polyalkylene terephthalates, polyhydroxyalkanoates (PHA), polybutylene succinates (PBS), polybutylene succinate adipates (PBSA);
polyethers;
polyether ketones;
thermoplastic polyurethanes (TPU);
polysulfides;
polysulfones;
natural rubber
   and mixtures thereof.

It may be provided that the polymer is a halogen-containing polymer. In this context, a halogen-containing polymer is in particular a hydrocarbon-based polymer in which at least one hydrogen atom per monomer unit has been replaced by one of the halogens fluorine, chlorine, bromine or iodine. In the case of a copolymer, at least one hydrogen atom per comonomer unit of at least one of the comonomers has been replaced by one of the halogens fluorine, chlorine, bromine or iodine. It may be provided that the halogen-containing polymer comprises, or is, a chlorine-containing polymer, a fluorine-containing polymer or a chlorine- and fluorine-containing polymer. It may be provided that the halogen-containing polymer is selected from polyvinyl chloride, chlorinated polyethylene, polytetrafluoroethylene, polytrichlorofluoroethylene, polyvinylidene fluoride or mixtures of two or more thereof. It may be provided that the halogen-containing polymer comprises polyvinyl chloride. It may be provided that the halogen-containing polymer is polyvinyl chloride.

It may be provided that the halogen-containing polymer consists of at least one first polyvinyl chloride and of at least one second polyvinyl chloride. It may be provided that the halogen-containing polymer consists of a first polyvinyl chloride and of a second polyvinyl chloride. It may be provided that the first polyvinyl chloride and the second polyvinyl chloride are present in the halogen-containing polymer in a weight ratio selected from the group consisting of from 10:1 to 1:10, from 5:1 to 1:5 and from 2:1 to 1:2, in particular in a weight ratio of approximately 6:4.

It may be provided that the first polyvinyl chloride has a K value according to DIN EN ISO 1628-2 (in the version valid on the filing date) selected from the group consisting of from 60 to 70, from 65 to 69, from 65 to 68 and 67.5 to 68.5, in particular approximately 68. It may be provided that the first polyvinyl chloride has a bulk density according to DIN EN ISO 60 (in the version valid on the filing date) selected from the group consisting of from 0.4 to 0.8 g/cm³ and from 0.5 to 0.6 g/cm³, in particular approximately 0.57. It may be provided that the first polyvinyl chloride has a value of sieve analysis—residue on 0.063 mm sieve according to DIN EN ISO 4610 (in the version valid on the filing date) selected from the group consisting of at least 90% and at least 95%, in particular at least approximately 96%. It may be provided that the first polyvinyl chloride has a value of sieve analysis—residue on 0.250 mm sieve according to DIN EN ISO 4610 (in the version valid on the filing date) selected from the group consisting of at least 1% and at least 2%, in particular at least approximately 3%. It may be provided that the first polyvinyl chloride has a proportion of volatile constituents according to DIN EN ISO 1269 selected from the group consisting of at most 1% and at most 0.5%, in particular at most approximately 0.3%. It may be provided that the first polyvinyl chloride has a plasticizer absorption according to ISO 4608 (in the version valid on the filing date) selected from the group consisting of from 10 to 30%, from 15 to 25% and from 18 to 22%, in particular approximately 20%. A corresponding commercially available first polyvinyl chloride is, for example, Vynova S6830.

It may be provided that the second polyvinyl chloride has a K value according to DIN EN ISO 1628-2 (in the version valid on the filing date) selected from the group consisting of from 60 to 70, from 63 to 68, from 65 to 68, from 65 to 67 and from 65.5 to 66.5, in particular approximately 66. It may be provided that the second polyvinyl chloride has a bulk density according to DIN EN ISO 60 (in the version valid on the filing date) selected from the group consisting of from 0.4 to 0.8 g/cm³ and from 0.5 to 0.6 g/cm³, in particular approximately 0.56. It may be provided that the second polyvinyl chloride has a value of sieve analysis—residue on 0.063 mm sieve according to DIN EN ISO 4610 (in the version valid on the filing date) selected from the group consisting of at least 90% and at least 95%, in particular at least approximately 97%. It may be provided that the second polyvinyl chloride has a value of sieve analysis—residue on 0.200 mm sieve according to DIN EN ISO 4610 (in the version valid on the filing date) selected from the group consisting of at most 20% and at most 17%, in particular at most approximately 15%. It may be provided that the second polyvinyl chloride has a proportion of volatile constituents according to DIN EN ISO 1269 selected from the group consisting of at most 1% and at most 0.5%, in particular at most approximately 0.3%. A corresponding commercially available second polyvinyl chloride is, for example, Primex S 6658 from vestolit.

It may be provided that the lignin derivative, in particular lignosulfonate, is comprised in the composition in an amount of 0.8 to 8% by weight, preferably of 1.6 to 8% by weight, particularly preferably of 2.4 to 8% by weight, based on the total weight of the composition.

It may be provided that the extrusion profile is an extruded frame profile, in particular window frame profile or door profile, or an extruded tubular profile.

It may be provided that the extrusion profile comprises, in particular comprises or consists of at least 50% by weight, 60% by weight, 70% by weight, 80% by weight, 90% by weight, 95% by weight, 98% by weight or 99% by weight, the composition according to one of aspects 1 to 4. In particular, the extrusion profile can be free of discrete reinforcements, such as reinforcements and inserts, for example steel inserts, continuous fibers and/or organosheets. Furthermore, the extrusion profile can be free of foam material, in particular free of surrounding foams and/or foam stabilizers.

According to an eighth aspect, the disclosure relates to the use of a composition according to one of aspects 1 to 4 for producing an extrusion profile.

It may be provided here that the extrusion profile is one according to one of aspects 5 to 7. In particular, it may be provided that the extrusion profile is an extruded frame profile, window frame profile or door profile, or an extruded tubular profile.

It may be provided that the extrusion profile consists of the composition according to one of aspects 1 to 4. In particular, the extrusion profile can be free of discrete reinforcements, such as reinforcements and inserts, for example steel inserts, continuous fibers and/or organosheets.

According to a ninth aspect, the disclosure relates to a method for producing an extrusion profile, in particular according to aspects 5 to 7, comprising the steps of
a) providing a polysaccharide, a lignin derivative or a mixture of two or more thereof;
b) providing a polymer, in particular a halogen-containing polymer; and
c) blending the components provided in steps a) and b) to form a composition, in particular to form a composition according to one of aspects 1 to 4;
d) extruding the composition to form the extrusion profile.

It may be provided that the polysaccharide, the lignin derivative or the mixture is comprised in the composition in step a) to an extent of at least 3% by weight, preferably at least 4% by weight, 5% by weight, 6% by weight, 7% by weight or 8% by weight, based on the total weight of the composition, and is dried before the blending in step c), in particular at 60° C. to 100° C., preferably at about 80° C.

It may be provided that step c) further comprises the homogenizing of the composition, in particular at a temperature of 100° C. to 150° C., preferably at about 125° C., and wherein step c) preferably further comprises a cooling of the composition downstream of the homogenizing, in particular to 30° C. to 60° C., preferably to 45° C.

Further properties, features and advantages of the disclosure are illustrated below by means of a description of preferred exemplary embodiments of the disclosure and on the basis of the accompanying exemplary drawing and measurement results.

### Exemplary Embodiments

### Comparative Example (VB)

Firstly, for a comparative example, the following components were mixed to form a plastics composition in the form of a homogeneous dry blend:
240 kg (60 phr) of a first polyvinyl chloride (Vynova S6830),
160 kg (40 phr) of a second polyvinyl chloride (Primex S 6658 from vestolit),
32-40 kg (8-10 phr) of CaCO₃ (Precarb 400),
16 kg (4 phr) of TiO2 pigment (TiO₂ RFK-3),
0.64 kg (0.16 phr) of blue pigment (pigment blue),
0.64 kg (0.16 phr) of violet pigment (pigment violet),
1.2-2.4 kg (0.3-0.6 phr) of acrylic-based particles (Paraloid K125),

The abbreviation “kg” stands for kilograms. The abbreviation “phr” stands for parts by weight per hundred parts by weight of polyvinyl chloride. Commercially available products are indicated behind the constituents of the formulation in parentheses.

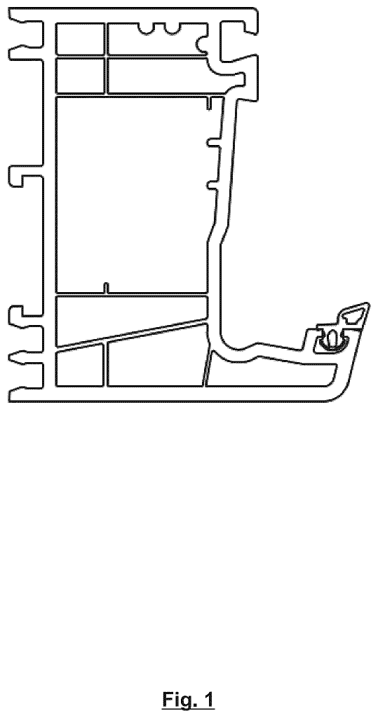

The plastic composition was homogenized in a hot mixing apparatus up to a temperature of 125° C. with the aid of blade mixers. Subsequently, the plastic composition was cooled to 45° C. in a cooling mixing apparatus by external water cooling and then filled at room temperature for further processing. In the next step, the plastic composition was extruded through a counter-rotating twin-screw extruder with parallel screw design and a screw diameter of 114 mm and a screw length of 364.8 cm and a window frame profile with a cross section as shown in FIG. 1 was produced.

### Comparative Example 2 (VB2)

For a second comparative example (VB2), the following components were mixed to form a plastics composition in the form of a homogeneous dry blend:
240 kg (60 phr) of a first polyvinyl chloride (Vynova S6830),
160 kg (40 phr) of a second polyvinyl chloride (Primex S 6658 from vestolit),
32-40 kg (8-10 phr) of CaCO₃ (Precarb 400),
14 kg of a polyvinyl chloride stabilizer (Baeropan R93320FP-3),
22 kg (5.5 PhR) of an acrylic polymer (Kaneka FM 56 K3),
16 kg (4 phr) of TiO2 pigment (TiO₂ RFK-3),
0.64 kg (0.16 phr) of blue pigment (pigment blue),
0.64 kg (0.16 phr) of violet pigment (pigment violet)

Subsequently, as described for the first comparative example (VB), a window frame profile was produced from the plastics composition.

### Exemplary Embodiment 1 (AB1)

For an exemplary embodiment 1, a window frame profile was produced as in the comparative example, with the sole exception that 12 kg (3 phr) of cellulose (Arbocell FD 600-30) were added to the plastics composition.

### Exemplary Embodiment 2 (AB2)

For an exemplary embodiment 2, a window frame profile was produced as in exemplary embodiment 1, with the sole exception that the amount of cellulose (Arbocell FD 600-30) was increased to 20 kg (5 phr) and the cellulose was dried at 80° C. before blending with the other components.

The inventors have recognized that, in the case of a cellulose fraction of more than 3%, air bubbles can occur in the product, here in the window frame profile, without this drying step. Furthermore, the inventors have recognized that, in the case of a cellulose content of less than 3%, as in exemplary embodiment 1, such air bubbles can be avoided even without this upstream drying step.

### Exemplary Embodiment 3 (AB3)

For an exemplary embodiment 3, a window frame profile was produced as in exemplary embodiment 1, with the sole exception that the amount of cellulose (Arbocell FD 600-30) was increased to 28 kg (7 phr) and the cellulose was dried at 80° C. before blending with the other components.

### Exemplary Embodiment 4 (AB4)

For an exemplary embodiment 4, a window frame profile was produced as in exemplary embodiment 1, with the sole exception that the amount of cellulose (Arbocell FD 600-30) was increased to 40 kg (10 phr) and the cellulose was dried at 80° C. before blending with the other components.

### Exemplary Embodiment 5 (AB5)

For an exemplary embodiment 5, a window frame profile was produced as in exemplary embodiment 1, with the sole exception that 0.8 kg (0.2 phr) of maleic acid-grafted polyethylenes (Licocene PE MA 4421) were added to the plastics composition.

### Exemplary Embodiment 6 (AB6)

For an exemplary embodiment 6, a window frame profile was produced as in exemplary embodiment 5, with the sole exception that the amount of maleic acid-grafted polyethylenes (Licocene PE MA 4421) was increased to 2 kg (0.5 phr).

### Exemplary Embodiment 7 (AB7)

For an exemplary embodiment 7, a window frame profile was produced as in exemplary embodiment 5, with the sole exception that the amount of maleic acid-grafted polyethylenes (Licocene PE MA 4421) was increased to 4 kg (1 phr).

### Exemplary Embodiment 8 (AB8)

For an exemplary embodiment 8, a window frame profile was produced as in exemplary embodiment 5, with the sole exception that 0.2-0.4 kg (0.05-0.1 phr) of Fischer-Tropsch paraffin (Vestowax H2050 MG) were added to the plastics composition.

### Exemplary Embodiment 9 (AB9)

For an exemplary embodiment 9, a window frame profile was produced as in exemplary embodiment 5, with the sole exception that 0.020-0.04 kg (0.005-0.01 phr) of oxidized polyethylenes (AC307A) were added to the plastics composition.

### Exemplary Embodiment 10 (AB10)

For an exemplary embodiment 10, a window frame profile was produced as in exemplary embodiment 5, with the sole exception that 0.6-1.2 kg (0.15-0.3 phr) of a low density polyethylene (LDPE wax from Ceralene 2E) were added to the plastics composition.

### Exemplary Embodiment 11 (AB11)

For an exemplary embodiment 11, a window frame profile was produced as in exemplary embodiment 5, with the sole exception that 0.6-2.0 kg (0.15-0.5 phr) of 12-hydroxystearic acid were added to the plastics composition.

### Exemplary Embodiment 12 (AB12)

For an exemplary embodiment 12, the following components were mixed to form a plastics composition in the form of a homogeneous dry blend:
240 kg (60 phr) of a first polyvinyl chloride (Vynova S6830),
160 kg (40 phr) of a second polyvinyl chloride (Primex S 6658 from vestolit),
22 kg (5.5 PhR) of an acrylic polymer (Kaneka FM 56 K3),
32-40 kg (8-10 phr) of CaCO₃ (Precarb 400/Reverte 95T),
16 kg (4 phr) of TiO2 pigment (TiO₂ RFK-3),
0.64 kg (0.16 phr) of blue pigment (pigment blue),
0.64 kg (0.16 phr) of violet pigment (pigment violet),
12 kg (3 phr) of cellulose (Arbocell FD 600-30),
0.8 kg (0.2 phr) of maleic acid-grafted polyethylenes (Licocene PE MA 4421),
0.6-1.6 kg (0.15-0.4 phr) of calcium stearate (Ligastar CA 600),
2.4-4.0 kg (0.6-1.0 phr) of zinc stearate (Ligastar Zn 101/6),
0.2-0.4 kg (0.05-0.1 phr) of calcium acetylacetonate,
0.2-1.0 kg (0.05-0.25 phr) of tris(2-hydroxyethyl)isocyanurates (THEIC),
0.6-2.0 kg (0.15-0.5 phr) of Mg(OH)₂ (Luvomaag H002),
0.16-0.4 kg (0.04-0.1 phr) of sodium aluminosilicate (Zeolite F),
1.2-2.4 kg (0.3-0.6 phr) of acrylic-based particles (Paraloid K125),
0.2-1.0 kg (0.05-0.25 phr) of β-diketone,
0.2-0.6 kg (0.05-0.15 phr) of octadecyl-[3-(3,5-di-tert-butyl-4-hydroxyphenyl)propionate] (Irganox 1076),
0.6-2.0 kg (0.15-0.5 phr) of 12-hydroxystearic acid,
0.4-1.6 kg (0.1-0.4 phr) of hydrogenated castor oil (Loxiol G15),
0.6-1.2 kg (0.15-0.3 phr) of low density polyethylene (LDPE wax from Ceralene 2E),
0.2-0.4 kg (0.05-0.1 phr) of Fischer-Tropsch paraffin (Vestowax H2050 MG),
0.8 kg (0.2 phr) of CaCO₃ (Microcarb 95T) and
0.02-0.04 kg (0.005-0.01 phr) of oxidized polyethylenes (AC307A).

Subsequently, as described for exemplary embodiment 1, a window frame profile was produced from the plastics composition.

### Exemplary Embodiment 13 (AB13)

For an exemplary embodiment 13, a window frame profile was produced as in exemplary embodiment 12, with the sole exception that the 12 kg of cellulose (Arbocell FD 600-30) were replaced by 12 kg (3 phr) of lignosulfonate (Starlig@Ca from LignoStar).

### Exemplary Embodiment 14 (AB14)

For an exemplary embodiment 14, the following components were mixed to form a plastics composition in the form of a homogeneous dry blend:
225 kg (60 phr) of a first polyvinyl chloride (Vynova S6830),
150 kg (40 phr) of a second polyvinyl chloride (Primex S 6658 from vestolit),
32-40 kg (8-12 phr) of CaCO₃ (Precarb 400/Reverte 95T),
0.8 kg (0.2 phr) of maleic acid-grafted polyethylenes (Licocene PE MA 4421),
38 kg (10 phr) of cellulose (Arbocell FD 600-30),
21 kg (5.5 PhR) of an acrylic polymer (Kaneka FM 56 K3),
15 kg (4 phr) of TiO2 pigment (TiO₂ RFK-3),
0.6 kg (0.16 phr) of blue pigment (pigment blue),
0.6 kg (0.16 phr) of violet pigment (pigment violet),
0.6-1.6 kg (0.15-0.4 phr) of calcium stearate (Ligastar CA 600),
2.4-4.0 kg (0.6-1.0 phr) of zinc stearate (Ligastar Zn 101/6),
0.2-0.4 kg (0.05-0.1 phr) of calcium acetylacetonate,
0.2-1.0 kg (0.05-0.25 phr) of tris(2-hydroxyethyl)isocyanurates (THEIC),
0.6-2.0 kg (0.15-0.5 phr) of Mg(OH)₂ (Luvomaag H002),
0.16-0.4 kg (0.04-0.1 phr) of sodium aluminosilicate (Zeolite F),
1.2-2.4 kg (0.3-0.6 phr) of acrylic-based particles (Paraloid K125),
0.2-1.0 kg (0.05-0.25 phr) of β-diketone,
0.2-0.6 kg (0.05-0.15 phr) of octadecyl-[3-(3,5-di-tert-butyl-4-hydroxyphenyl)propionate] (Irganox 1076),
0.6-2.0 kg (0.15-0.5 phr) of 12-hydroxystearic acid,
0.4-1.6 kg (0.1-0.4 phr) of hydrogenated castor oil (Loxiol G15),
0.6-1.2 kg (0.15-0.3 phr) of low density polyethylene (LDPE wax from Ceralene 2E),
0.2-0.4 kg (0.05-0.1 phr) of Fischer-Tropsch paraffin (Vestowax H2050 MG),
0.02-0.04 kg (0.005-0.01 phr) of oxidized polyethylenes (AC307A).

Subsequently, as described for exemplary embodiment 1, a window frame profile was produced from the plastics composition.

The composition of AB14 differs in particular from AB12 in that the cellulose fraction was increased from 3 phr to 10 phr and the 0.8 kg (0.2 phr) of CaCO₃ (Microcarb 95T) was omitted.

### Tensile Tests:

To determine the influence of the cellulose content on the tensile strength and elongation at break, specimens were produced from Comparative Examples 1 and 2 (VB and VB2) and Exemplary Embodiments 1 to 4 and also 12 and 14 (AB1, AB2, AB3, AB4, AB12 and AB14) by sawing and milling. The tensile tests were carried out in accordance with DIN EN ISO 527-1 (in the version valid on the filing date). For this purpose, the specimens were clamped uniformly and loaded with a preload of 1.0N. They were loaded with a tensile speed of 100 mm/min. The tensile elongation tests were carried out with the Zwick/Roell Z0.5 tester. For each specimen, three test specimens were measured and the mean values of tensile strength and elongation at break were determined.

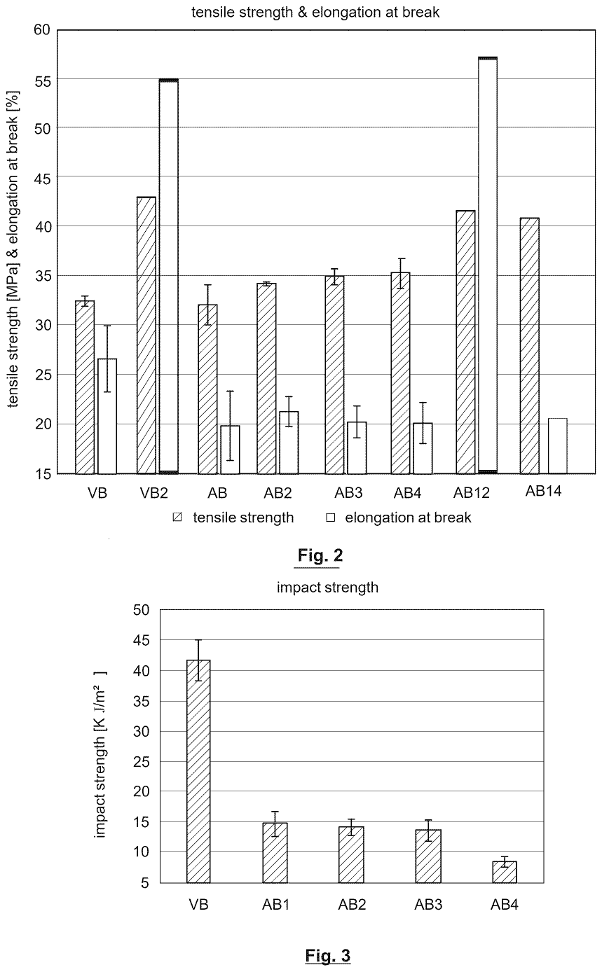

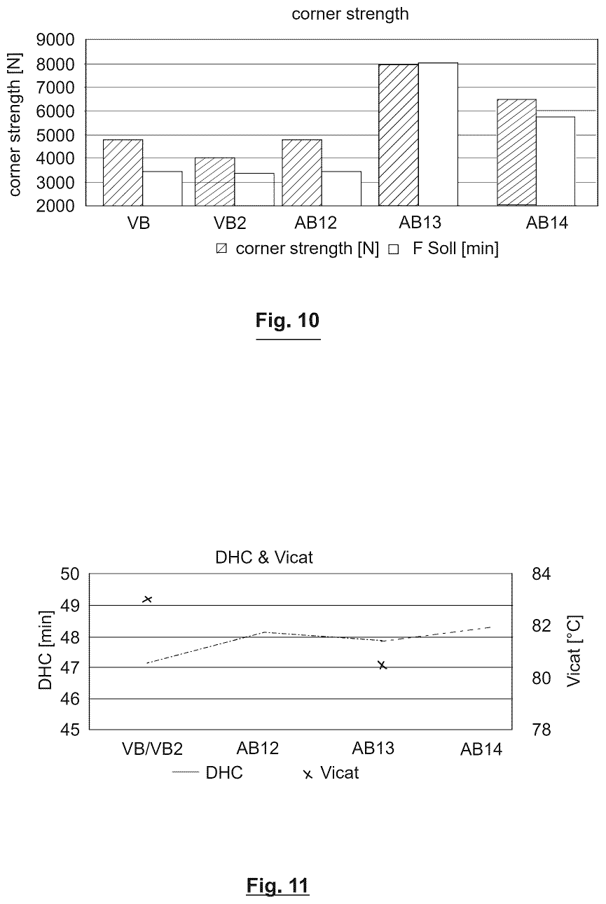

The test results are shown in FIG. 2. As can be seen, in exemplary embodiments 1 to 4, a lower elongation at break was observed compared with the first comparative example (VB). In exemplary embodiment 1, in addition, a slightly reduced tensile strength was observed compared with the comparative example. In exemplary embodiments 2 to 4, however, it was possible to demonstrate an increased tensile strength compared with the comparative example, which increases with the cellulose content. In the second comparative example (VB2), which differs from the first comparative example essentially by the addition of a polyvinyl chloride stabilizer (Baeropan R93320FP-3) and an acrylic polymer (Kaneka FM 56 K3), it was possible to achieve a significantly increased tensile strength and elongation at break compared with the first comparative example (VB). However, this increase in the tensile strength was accompanied by a drop in the corner strength (compare FIG. 10). By contrast, with the comparative example AB12, it was possible to achieve tensile strength and elongation at break values comparable as in the case of VB2, without losing corner strength compared with the first comparative example (VB). In particular, the possibility with AB12 of increasing the tensile strength compared with VB, without having to make reductions in the corner strength, is attributed by the inventors to the combination of cellulose with zinc and calcium stearate. With exemplary embodiment 14 (AB14), which differs in particular from exemplary embodiment 12 (AB12) by the increase in the cellulose content from 3 phr to 10 phr, it was even possible to increase the corner strength significantly compared with the corner strengths of VB and AB12 (compare FIG. 10) without having to accept significant losses in the tensile strength (compare FIG. 2). Although with the increase in the cellulose content in the case of AB14, the elongation at break decreased significantly compared with VB12 (compare FIG. 2). For the use of the plastic composition in extrusion profiles, in particular window frame profiles, however, the increased corner strength has proved to be so advantageous that the reduced elongation at break is acceptable.

### Impact Strength

To determine the influence of the cellulose content on the impact strength, specimens were likewise produced from the comparative example and Exemplary Embodiments 1 to 4 by sawing and milling. The impact strength was determined according to ISO 179-1/1fC (double V notch; in the version valid on the filing date/DV). The specimens contain V notches with a depth of 2 mm. The specimen was clamped upright. Three specimens were measured in each case. A pendulum impact mechanism (5102.202Zwick 5102B. AB No. 321499) with an impact pendulum of 1 or 4 J was used. The test results are shown in FIG. 3. As can be seen, when cellulose was used, a considerable reduction in the impact strength was observed, which worsened with increasing cellulose content.

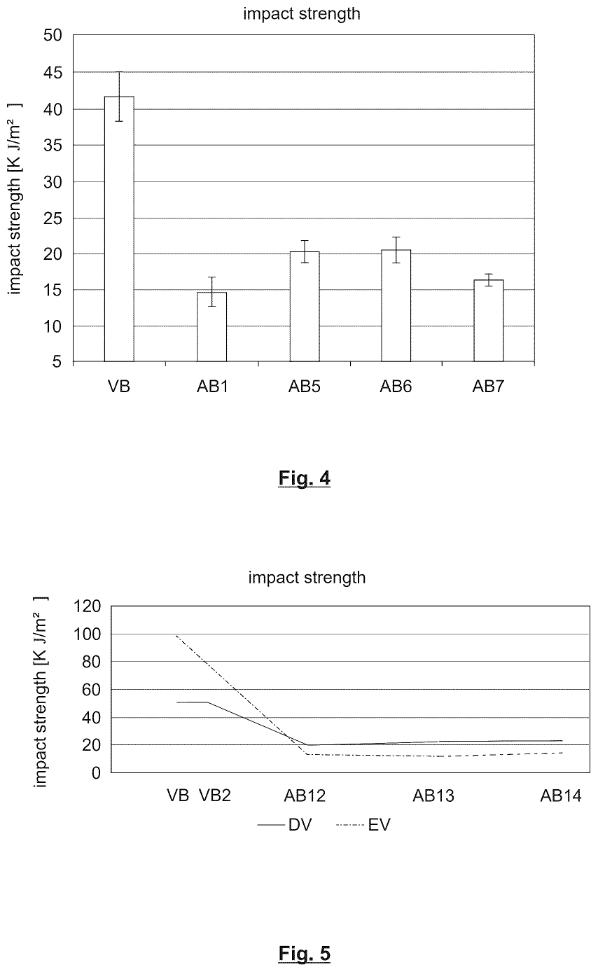

To determine the influence of adhesion promoters, in particular of maleic acid-grafted polyethylenes, on the impact strength of cellulose-containing plastics compositions, specimens were furthermore produced from exemplary embodiments 5 to 7 by sawing and milling and examined for their impact strength as described above. A comparison of the results of the comparative example, exemplary embodiment 1 and exemplary embodiments 5 to 7 is shown in FIG. 4. As can be seen, the loss in impact strength due to the use of cellulose (compare VB and AB1) could be partially compensated for by the use of an adhesion promoter (compare AB1 with AB5 to AB7). The best results were achieved here with the use of 0.2 to 0.5 ppr of adhesion promoter (compare AB5 and AB6). A further increase in the adhesion promoter content led to a further drop in the impact strength (compare AB7).

Finally, specimens were produced from the second comparative example (VB2) and exemplary embodiments 12, 13 and 14 (AB12, AB13 and AB14) by sawing and milling and examined for their impact strength as described above. In addition, the impact strength was examined in accordance with DIN EN ISO 179-1/1eA (single V notch/EV). A comparison of the results of comparative examples 1 and 2 (VB and VB2) and exemplary embodiments 12, 13 and 14 is shown in FIG. 5. As can be seen, in both exemplary embodiments 12, 13 and 14, a significantly lower impact strength is present than in comparative examples VB and VB2. However, in exemplary embodiments 12, 13 and 14, it was possible to achieve a higher impact strength (approximately 20-22 kJ/m2 according to ISO 179-1/1fC double V notch/DV) than in exemplary embodiment 1 (approximately 14 kJ/m 2 according to ISO 179-1/1fC double V notch/DV).

### Rheology Properties

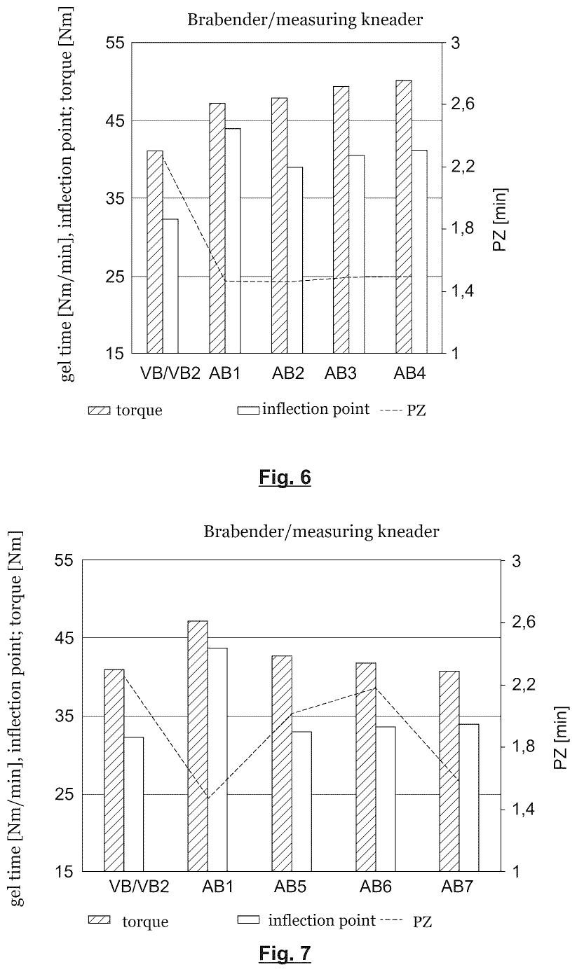

To examine the influence of cellulose, adhesion promoter and lubricant on the rheology of the plastics composition, plastification time (PZ), inflection point, torque and gel time (GZ) of the plastics composition of the comparative example and exemplary embodiments 1 to 11 were measured using a Brabender measuring kneader. The measurement results are shown graphically in FIGS. 6 and 7.

As can be seen, the use of cellulose leads to an increase in torque and inflection point (compare FIG. 6, VB gv. AB1 to AB4). Thereby, the torque increases with the cellulose content. The plastification time (PZ), on the other hand, falls significantly when using cellulose compared to the comparative example (VB) without cellulose. Since similar rheological properties were achieved in the second comparative example (VB2) as in the first comparative example (VB), the results of the first comparative example (VB) are assigned to VB2 in FIGS. 6, 7 and 8. As can be seen from FIG. 7, the plastification time (PZ) can be increased by the use of adhesion promoters (compare AB5 to AB7 with AB1). In particular in the range between 0.2 and 0.5 ppr, a plastification time (PZ) is kept at a similar level to that of the comparative examples 1 and 2 (VB and VB2). The torque and the inflection point are lowered by the use of the adhesion promoter (compare AB5 to AB7 with AB1). Thereby, the torque decreases slightly with increasing proportion of adhesion promoter, whereas the inflection point increases slightly with increasing proportion of adhesion promoter.

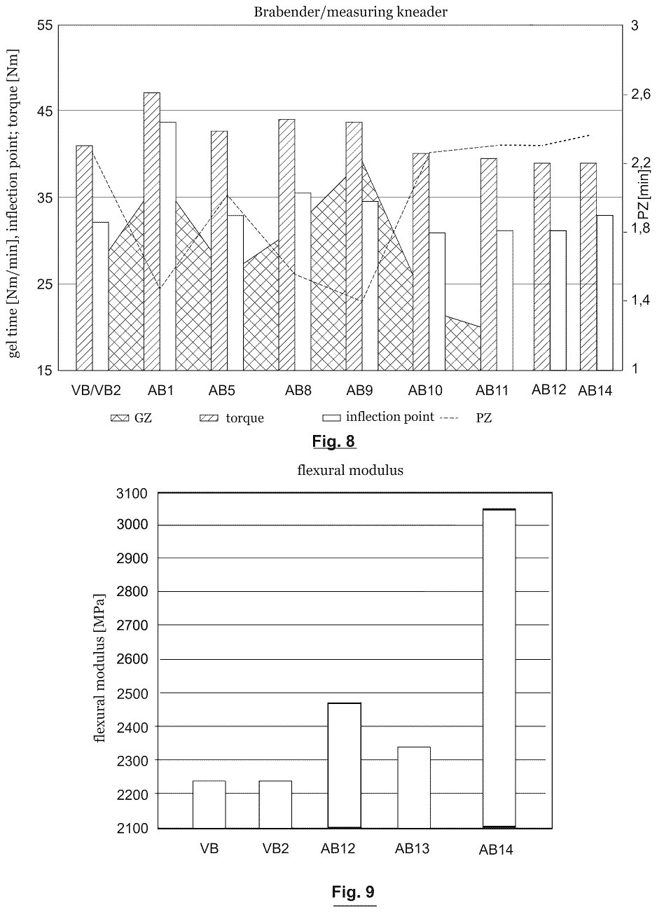

FIG. 8 illustrates the influence of different lubricants (AB8 to AB11) on the rheology of a plastics composition with cellulose and adhesion promoter (AB5). As can be seen, the lubricants Fischer-Tropsch paraffin (AB8) and oxidized polyethylenes (AB9) lower the plastification time and lead to a slight increase in torque and inflection point and to a sharp increase in gel time (GZ), in each case compared to AB5. In contrast, the lubricants LDPE wax (AB10) and 12-hydroxystearic acid (AB11) increase the plastification time, slightly lower the torque and the inflection point and significantly lower the gel time, in each case compared to AB5.

Inter alia on the basis of exemplary embodiments AB1 to AB11 described above, plastics compositions 12, 13 and 14 were developed which have almost unchanged rheological properties compared to comparative examples 1 and 2 (VB and VB2), in particular with regard to torque, inflection point, plastification time and gel time. Torque, inflection point and plastification time of AB12 and AB14 are likewise shown in FIG. 8. It was thereby possible to create a material which, by the use of cellulose in the case of AB12 and AB14 and lignosulfonate in the case of AB13, increases the proportion of biopolymers, in particular biodegradable and biobased materials, in the plastics composition and thus increases the sustainability thereof, wherein the processability of the plastics composition by means of extruders was not impaired.

### Bending Test:

To determine the flexural modulus of comparative examples 1 and 2 (VB and VB2) and of exemplary embodiments 12, 13 and 14 in accordance with DIN EN ISO 178, bending rods having a sample geometry of 80×10×2.5 mm were prepared. A universal Zwick testing machine (DO 728024) was used for the investigations. Five specimens were measured in each case. The flexural modulus was determined at a testing speed of 1 mm/min and the bending strength at 1 mm/min. The results are shown in FIG. 9. As can be seen, for both exemplary embodiments 12, 13 and 14, a significant increase in the flexural modulus was demonstrated compared with comparative examples 1 and 2 (VB and VB2). As a result, the mechanical load-bearing capacity of exemplary embodiments 12, 13 and 14 could be increased in this respect, while the process requirements, the energy consumption and the weight were reduced compared with solutions with separate reinforcement, such as steel insert or organosheet, and the recyclability was increased. A particularly significant increase in the flexural modulus was observed in exemplary embodiment 14.

### Corner Strength

FIG. 10 indicates measurement results for the corner strength and F Soll(min) of the window frame profile. As can be seen, in particular with exemplary embodiments 13 and 14, a significant improvement in the corner strength and of F Soll(min) was achieved. In particular, with exemplary embodiment 14, an increase in the corner strength, in the flexural modulus and in the tensile strength was achieved compared with the first comparative example (VB), and an increase in the corner strength and in the flexural modulus was achieved compared with the second comparative example (VB2). The measurements were carried out in accordance with DIN EN 514:2018-04.

### Thermal Resistance

FIG. 11 shows measurement results for the Vicat softening temperature (Vicat) of comparative examples 1 and 2 (VB and VB2) and of exemplary embodiments 12, 13 and 14. For this purpose, specimens with a base area of 10 mm×10 mm were in each case cut out of the window frame profiles. In the case of wall thicknesses of less than 2.8 mm, two specimens were placed one on top of the other, such that the summed wall thickness was between 3 mm and 6.5 mm. The test was carried out in accordance with method A (force of 10N±0.2 ) of DIN EN ISO 306. The HDT/VICAT instrument from the company CEAST was used. As can be seen, with exemplary embodiments 12, 13 and 14, the Vicat softening temperature was increased and thus the thermal resistance was increased compared with the comparative example.

Furthermore, FIG. 11 shows measurement results for the thermostability by means of dehydrochlorination methods (DHC) of comparative examples 1 and 2 (VB and VB2) and of exemplary embodiments 12 and 13. The thermostability was carried out with a Metrohm 763 PVC Thermomat tester (2.763.0014 i.e. mains voltage 230 V) in accordance with standard: ISO 182-3. As can be seen, exemplary embodiment 13 led to a slight drop in the DHC value (time until hydrogen chloride was released) from approximately 49 minutes to approximately 47 minutes. By contrast, in exemplary embodiments 12, the DHC value could be increased to approximately 57 minutes (not shown) and in exemplary embodiment 14 to approximately 60 minutes (not shown).

The features disclosed in the above description, the figures and the claims can be significant both individually and in any desired combination for the realization of the disclosure in the various configurations.

1. A plastic composition for production of extruded profiles, comprising:
0.1 to 40% by weight of a polysaccharide, a lignin derivative or a mixture of two or more thereof; and
10 to 99.9% by weight of a halogen-containing polymer,
wherein each is based on a total weight of the plastic composition.

2. The plastic composition according to claim 1, wherein the polysaccharide, the lignin derivative or the mixture of two or more thereof is comprised in the plastic composition in an amount of 1 to 9% by weight, based on the total weight of the plastic composition.

3-5. (canceled)

6. The plastic composition according to claim 1, wherein the halogen-containing polymer comprises polyvinyl chloride.

7-15. (canceled)

16. The plastic composition according to claim 1, wherein the plastic composition further comprises a lubricant, wherein the lubricant comprises at least one selected from the group consisting of: 12-hydroxy stearic acid, hydrogenated castor oil, low density polyethylene (LDPE) wax, Fischer-Tropsch paraffin, oxidized polyethylenes, complex esters and a mixture of two or more thereof.

17-21. (canceled)

22. The plastic composition according to claim 1, wherein the plastic composition further comprises CaCO₃.

23. The plastic composition according to claim 22, wherein the CaCO3 is comprised in the plastic composition in an amount of 1 to 15 % by weight, based on the total weight of the plastic composition.

24. The plastic composition according to claim 1, wherein the plastic composition further comprises an adhesion promoter, wherein the adhesion promoter is maleic acid-grafted polyethylene.

25. The plastic composition according to claim 24, wherein the adhesion promoter is comprised in the plastic composition in an amount of 0.01 to 5 % by weight, preferably of 0.04 to 1.6 % by weight, more preferably of 0.08 to 0.8 % by weight, most preferably of 0.16 to 0.4 % by weight, based on the total weight of the plastic composition.

26-62. (canceled)

63. A plastic composition for production of extruded profiles, comprising:
a polysaccharide, a lignin derivative or a mixture of two or more thereof;
a polymer; and
a heat stabilizer, wherein the heat stabilizer comprises a mixture of zinc stearate and calcium stearate,
wherein each is based on a total weight of the plastic composition.

64-68. (canceled)

69. The plastic composition according to claim 63, wherein the heat stabilizer is comprised in the plastic composition in an amount of 0.01 to 10 % by weight, based on the total weight of the plastic composition.

70. The plastic composition according to claim 63, wherein the heat stabilizer comprises a mixture of zinc stearate and calcium stearate in a weight ratio of 1:1 to 5:1 in an amount of at least 90 wt.-%, based on the total weight of the heat stabilizer.

71-92. (canceled)

93. A plastic composition for production of extruded profiles, comprising:
a polysaccharide, a lignin derivative or a mixture of two or more thereof;
a polymer; and
a nucleophilic co-stabilizer,
wherein each is based on a total weight of the plastic composition.

94. The plastic composition according to claim 93, wherein the nucleophilic co-stabilizer is comprised in the plastic composition in an amount of 0.01 to 4 % by weight, based on the total weight of the plastic composition.

95. The plastic composition according to claim 93, wherein the nucleophilic co-stabilizer is selected from the group consisting of tris(2-hydroxyethyl)isocyanurate, β-diketone, calcium acetylacetonate and a mixture of two or more thereof.

96-124. (canceled)

125. An extruded profile comprising the plastic composition according to claim 1, wherein the extruded profile is an extruded window frame profile or an extruded tubular profile.

126-135. (canceled)

136. The plastic composition according to claim 93, wherein the nucleophilic co-stabilizer comprises a mixture of tris(2-hydroxyethyl)isocyanurate, β-diketone and calcium acetylacetonate.

137. The plastic composition according to claim 94, wherein the nucleophilic co-stabilizer is selected from the group consisting of tris(2-hydroxyethyl)isocyanurate, β-diketone, calcium acetylacetonate and a mixture of two or more thereof.

138. The plastic composition according to claim 1, wherein the plastic composition further comprises a lubricant, wherein the lubricant comprises a mixture of 12-hydroxy stearic acid, hydrogenated castor oil, low density polyethylene (LDPE) wax, Fischer-Tropsch paraffin and oxidized polyethylenes.

139. The plastic composition according to claim 1, wherein the extruded profile is an extruded window frame profile or tubular profile.
